(19) United States
(12) Patent Application Publication
(10) Pub. No.: US 2024/0039799 A1
(43) Pub. Date: Feb. 1, 2024

(54) PREDICTING RANDOM ACCESS PROCEDURE PERFORMANCE BASED ON AI/ML MODELS

(71) Applicant: Telefonaktiebolaget LM Ericsson (publ), Stockholm (SE)

(72) Inventors: Ali Parichehrehteroujeni, Linköping (SE); Joel Berglund, Linköping (SE); Henrik Rydén, Stockholm (SE)

(21) Appl. No.: 18/266,006

(22) PCT Filed: Dec. 10, 2021
(86) PCT No.: PCT/EP2021/085148

§ 371 Date: Jun. 8, 2023

Related U.S. Application Data
(60) Provisional application No. 63/124,423, filed on Dec. 11, 2020.

(51) Int. Cl. H04L 41/16; H04W 74/08; H04W 24/02

(52) U.S. Cl. CPC H04L 41/16; H04W 74/0833; H04W 24/02

(57) ABSTRACT

Systems and methods of the present disclosure are directed to a computer implemented method performed by a Wireless Communication Device (WCD). The method includes receiving information from a network node. The information includes an Artificial Intelligence (AI)/Machine Learning (ML) model that outputs a set of output parameters that represent whether a Random Access (RA) procedure to be performed by the WCD will be successful based on a set of input parameters. Or the information includes information about or that characterizes the AI/ML model that enables the WCD to build the AI/ML model that outputs the set of output parameters that represent whether the RA procedure to be performed by the WCD will be successful based on the set of input parameters. The method includes adapting one or more RA parameters for the RA procedure based on the AI/ML model.

### RELATED APPLICATIONS

This application claims the benefit of provisional patent application Ser. No. 63/124,423, filed Dec. 11, 2020, the disclosure of which is hereby incorporated herein by reference in its entirety.

### TECHNICAL FIELD

The present disclosure relates to random access procedure, and, more specifically, utilization of artificial intelligence/machine learning to optimize random access procedure.

### BACKGROUND

### Log and Repotting of RACH Information in LTE

In Third Generation Partnership Project (3GPP) Long Term Evolution (LTE), the report of Random Access Channel (RACH) information when random access procedure is performed may be requested by the network via the User Equipment (UE) Information procedure defined in the Radio Resource Control (RRC) specifications (see 3GPP Technical Specification (TS) 36.331 V16.2.1, section 5.6.5), in the case where a RACH procedure was successful. An excerpt from section 5.6.5 of 3GPP TS 36.331 V16.2.1 describing the UE Information procedure is reproduced below:

The RRC messages UEInformationRequest and UEInformationResponse are defined in 3GPP TS 36.331 V16.2.1 as shown in the following excerpt from TS 36.331:

### RACH Configuration in NR

As in LTE, a random access procedure is described in the 3GPP New Radio (NR) Medium Access Control (MAC) specifications, and parameters are configured by RRC (e.g., in system information or handover (RRCReconfiguration with reconfigurationWithSync)). Random access is triggered in many different scenarios such as, for example, when the UE is in RRC_IDLE or RRC_INACTIVE and wants to access a cell that it is camping on (i.e., transition to RRC_CONNECTED).

In NR, RACH configuration is broadcasted in System Information Block 1 (SIB1) as part of the servingCellConfigCommon (with both downlink (DL) and uplink (UL) configurations), where the RACH configuration is within the uplinkConfigCommon. The exact RACH parameters are within what is called initialUplinkBWP, since this is the part of the UL frequency the UE is to access and search for RACH resources.

The following excerpts from section 6.3.2 of 3GPP TS 38.331 V16.2.0 provide definitions of two information elements, namely, RACH-ConfigGenefic and RACH-ConfigCommon.

### Contention-Based RACH (CBRA) in NR

In LTE, the RACH report to assist the network to perform RACH optimization contains an indication that collision was detected. With that information, it is clear that, at some point before that RACH procedure has succeeded, the same UE tried to access the network and happened to have a collision.

In NR, a mechanism also exists for contention resolution for contention-based random access.

### RACH Partitioning Per Beam in NR

In NR, random access resource selection needs to be performed within a cell depending on measurements performed on SSBs (Synchronization Signal Blocks) or CSI-RSs. A cell in NR is basically defined by a set of these SSBs that may be transmitted in one downlink beam (typical implementation for lower frequencies e.g. below 6 GHz) or multiple downlink beams (typical implementation for lower frequencies e.g. below 6 GHz). For the same cell, these SSBs carry the same Physical Cell Identifier (PCI) and a MIB. For standalone operation, i.e., to support UEs camping on an NR cell, they also carry the RACH configuration in SIB1, where the RACH configuration comprises a mapping between the detected SSB covering the UE at a given point in time and the PRACH configuration (e.g. time, frequency, preamble, etc.) to be used. For that, each of these beams may transmit its own SSB which may be distinguished by an SSB index. This is illustrated in FIG. 2.

The mapping between RACH resources and SSBs (or CSI-RS) is also provided as part of the RACH configuration (in RACH-ConfigCommon). Two parameters are relevant here:
#SSBs-per-PRACH-occasion: ⅛, ¼, ½, 1, 2, 8 or 16, which represents the number of SSBs per RACH occasion;
#CB-preambles-per-SSB preambles to each SS-block: within a RACH occasion, how many preambles are allocated.

To give a first example, if the number of SSBs per RACH occasion is 1 and if the UE is under the coverage of a specific SSB e.g. SSB index 2, there will be a RACH occasion for that SSB index 2. If the UE moves and is now under the coverage of another specific SSB e.g., SSB index 5, there will be another RACH occasion for that SSB index 5 i.e., each SSB detected by a given UE would have its own RACH occasion as illustrated in the example of FIG. 3. Hence, at the network side, upon detecting a preamble in a particular RACH occasion, the network knows exactly which SSB the UE has selected and, consequently, which downlink beam is covering the UE so that the network can continue the downlink transmission (e.g., Random Access Response (RAR), etc.). The mapping factor 1 is an indication that each SSB has its own RACH resource. That is, a preamble detected in a particular RACH resource indicates to the network which SSB the UE has selected. By knowing which SSB the UE has selected, the network also knows which DL beam the network should use to communicate with the UE (e.g., the network also knows which DL beam on which to send the RAR).

Note that each SSB typically maps to multiple preambles (different cyclic shifts and Zadoff-Chu roots) within a PRACH occasion, so that it is possible to have multiple different UEs transmitting in the same RACH occasion since they may be under the coverage of the same SSB. In a second example shown in FIG. 4, the number of SSBs per RACH occasion is 2. Hence, a preamble received in that RACH occasion indicates to the network that one of the two beams are being selected by the UE. So, either the network has means via implementation to distinguish these two beams and/or the network should perform a beam sweeping in the downlink by transmitting the RAR in both beams. This beam sweeping may be done by simultaneously transmitting the RAR on both beams. Alternatively, this beaming sweeping may be done by transmitting the RAR on one beam, waiting for a response from the UE, and transmitting the RAR on the other beam if no response is received.

Assuming now that in the first attempt the UE has selected an SSB (based on measurements performed in that cell), transmitted with initial power a selected preamble associated to the PRACH resource mapped to the selected SSB, and has not received a RAR within the RAR time window. According to the specifications, the UE may still perform preamble re-transmission (i.e., maximum number of allowed transmissions not reached).

### Differences in Contention Resolution in NR and LTE

As described in above, LTE collisions may occur in a cell because multiple UEs have selected the same RACH preamble and, consequently, could have transmitted in the same time/frequency PRACH resource. In NR, collisions occur when multiple UEs select the same preamble associated to the beam (i.e., UEs may have to select the same SSB and CSI-RS), otherwise the time/frequency RACH resource would be different, as there may be different mappings between beams and RACH resources.

The contention resolution process in NR is quite similar to the one in LTE. If multiple UEs under the coverage of the same downlink beam select the same preamble, they will also monitor PDCCH using the same RA-RNTI and receive the same RAR content, including the same UL grant for MSG3 transmission (among other things, e.g., timing advance, etc.). If both send MSG3 and if the network is able to decode at least one of them, a contention resolution exists (MSG4) so the UE knows that contention is resolved. As in LTE, that MSG4 addresses the UE either using a C-RNTI if one was allocated by the target, e.g. in case of handovers or in case the UE is in RRC_CONNECTED or a TC-RNTI (temporary C-RNTI) in case this is an incoming UE (e.g., from a state transition). As in LTE, in case the network addresses the UE with a TC-RNTI, it also includes in the MAC payload the UE identity used in MSG3 (e.g., resume identifier).

Then, thanks to that mechanism, the UE detecting this contention resolution message is able to detect if collision has occurred and if it needs to re-start RACH again. That is done by analyzing the content of the message or upon the expiry of the contention resolution timer.

If the content of the MSG4 has the UE's TC-RNTI assigned in MSG2 and if the contention resolution identity in the payload matches its identifier sent in MSG3, the UE considers contention resolved and is not even aware that there was any collision. If it has its TC-RNTI and the contention resolution identity in the payload does not match its identifier sent in MSG3, UE declares a collision and performs further actions such as declaring RACH failure or performing another RACH attempt.

In summary, contention is unresolved and collision detected in two cases:
MSG4 addressing TC-RNTI and UE Identities do not match;
Contention resolution timer expires.

If we make an analogy with the existing LTE solution for RACH optimization, the UE would log the occurrence of that event upon these cases.

The content resolution in NR is shown below as described in the MAC specifications (3GPP TS 38.321 V16.2.0):

### Differences in Power Ramping in NR and LTE

Assuming now that in the first random access attempt the UE has selected an SSB (based on measurements performed in that cell), it has transmitted with initial power a selected preamble associated to the PRACH resource mapped to the selected SSB, and it has not received a RAR within the RAR time window. According to the specifications, the UE may still perform preamble re-transmission (i.e., maximum number of allowed transmissions not reached).

As in LTE, at every preamble retransmission attempt, the UE may assume the same SSB as the previous attempt and perform power ramping similar to LTE. A maximum number of attempts is also defined in NR, which is also controlled by the parameter PREAMBLE_TRANSMISSION_COUNTER.

On the other hand, different from LTE, at every preamble retransmission attempt, the UE may alternatively select a different SSB, as long as that new SSB has an acceptable quality (i.e., its measurements are above a configurable threshold). In that case, when a new SSB (or, in more general term, a new beam) is selected, the UE does not perform power ramping, but transmits the preamble with the same previously transmitted power (i.e., UE shall not re-initiate the power to the initial power transmission). This is shown in FIG. 5.

For that reason, a new variable is defined in the NR MAC specifications (TS 38.321) called PREAMBLE_POWER_RAMPING_COUNTER, in case the same beam is selected at a retransmission. At the same time, the previous LTE variable still exists (PREAMBLE_TRANSMISSION_COUNTER) so that the total number of attempts is still limited, regardless of whether the UE performs SSB/beam re-selection or power ramping at each attempt.

Hence, if the initial preamble transmission, e.g., associated to SSB-2, does not succeed and the UE selects the same SSB/beam, PREAMBLE_POWER_RAMPING_COUNTER is incremented (i.e., set to 2 in this second attempt) and the transmission power will be:

PREAMBLE_RECEIVED_TARGET_POWER=preambleReceivedTargetPower+DELTA_PREAMBLE+1*PREAMBLE_POWER_RAMPING_STEP;

Else, if instead the UE selects a different SSB/beam, the PREAMBLE_POWER_RAMPING_COUNTER is not incremented (i.e., remains 1) and the transmission power will be as in the first transmission:

PREAMBLE_RECEIVED_TARGET_POWER=preambleReceivedTargetPower+DELTA_PREAMBLE; That preamble power ramping procedure, in case of multiple preamble

transmission attempts, is shown below as described in the MAC specifications (TS 38.321):

### Contention-Free Random Access (CFRA) in NR and FallBack to CBRA

In NR, as in LTE, the UE may be configured to perform CFRA e.g., during handovers. That configuration goes in the reconfigurationWithSync of IE ReconfigurationWithSync (which goes in the CellGroupConfig IE, transmitted in the RRCReconfiguration message), as shown in the cited excerpts of section 6.3.2 of TS 38.331 below:

One difference between NR and LTE shown above is that RACH resources may be mapped to beams (e.g., SSBs or CSI-RS resources that may be measured by the UE). Hence, when CFRA resources are provided, they are also mapped to beams and this may be done only for a subset of beams in a given target cell.

The consequence is that, to use CFRA resources, the UE needs to select a beam for which it has CFRA resources configured in the dedicated configuration. In the case of SSBs, for example, that may be found in the ssb-ResourceList which is a SEQUENCE (SIZE(1 . . . maxRA-SSB-Resources)) OF CFRA-SSB-Resource.

If an analogy with LTE is made, i.e., if the NR solution would have been the same as LTE, upon selecting a beam with CFRA resource (e.g., a beam from the configured list) and not receiving the RAR, the UE would keep selecting the same resource and ramp the power before retransmitting the preamble. However, as in the case of NR CBRA, the UE has the option upon every failed attempt to select another beam. And, that other beam may either be in the list of beams for CFRA or it may not. In the case the selected beam is not, the UE performs CBRA.

Also notice that there is a fallback between CSI-RS selection to SSB selection, in case CFRA is provided for CSI-RS resources. This is also captured in the MAC specifications (TS 38.321, see section 5.1.2 reproduced above):

### NR Beamforming

Use of multi-antenna techniques can increase the signal quality. By spreading the total transmission power wisely over multiple antennas, an array gain can be achieved which increases the signal quality. The transmitted signal from each antenna is formed in such way that the received signal from each antenna adds up coherently at the user, this is referred to as beam-forming. The precoding describes how to form each antenna in the antenna array in order to form a “beam.” Use of beamforming is one cornerstone in the NR technology, and beams can be shaped both in horizontal or vertical domain using the new advanced antenna systems. UE can for example assess beam qualities in NR from the serving or neighboring cell via measurements on the synchronization block (SSB), or via measurement on the CSI-RS resources.

### UE NR Beam Measurements

The measurement configuration for NR is described in 38.331 in Section 5.5.1 as follows:

### Problems with Existing Solutions

There currently exist certain challenge(s). In the current implementation, preamble received target power is tuned by the network using a parameter (preambleReceivedTargetPower) that is part of RACH Config Generic IE. This parameter is the same for all the UEs along the cell coverage. In other words, this parameter will be used by all the UEs no matter if they are close to the cell center or far from the cell center (i.e., close to the cell boundaries). Hence, the UE is mandated to try RACH attempts with transmission power level calculated based on the pathloss, preamble received target power (set by the network node), as well as power ramping step and number of RACH attempt.

Although this solution may assist the network to limit the potential interferences in uplink (if a UE starts transmitting at a high-power level), this may cause additional latency in the RACH procedure if the UE is required to ramp the transmission power level. In fact, in the current solution adopted in 3GPP MAC specification TS 38.321, finding the preamble transmission power is based on a trial and error approach. A UE potentially starts with the minimum transmission power and, if it does not successfully to receive a random-access response message, the UE ramps up the power level. This causes additional latency which may jeopardize the stringent quality of service/experience requirements, particularly for Ultra-Reliable Low-Latency Communication (URLLC) scenarios. In URLLC scenarios, for example in a factory automation scenario, a very low interruption time is required while the legacy RACH procedure (with stepwise increment of the transmission power) latency may take up to hundreds of milliseconds if the parameters are not set optimally.

### SUMMARY

In some embodiments, a computer implemented method performed by a Wireless Communication Device (WCD) is proposed. The method includes receiving information from a network node, the information including an Artificial Intelligence (AI)/Machine Learning (ML) model that outputs a set of output parameters that represent whether a Random Access (RA) procedure to be performed by the WCD will be successful based on a set of input parameters; or information about or that characterizes the AI/ML model that enables the WCD to build the AI/ML model that outputs the set of output parameters that represent whether the RA procedure to be performed by the WCD will be successful based on the set of input parameters. The method includes adapting one or more RA parameters for the RA procedure based on the AI/ML model. Thus, by adapting one or more RA parameters for the RA procedure, embodiments of the present disclosure may enable the possibility to optimize the random access configuration parameters to have a successful RACH transmission and avoid failure or additional delay caused by unwanted multiple preamble transmissions.

In some embodiments, the method further comprises performing the RA procedure based on the one or more adapted RA parameters.

In some embodiments, the method further comprises providing feedback about the AI/ML model to the network node.

In some embodiments, the feedback comprises an output of the AI/ML model and/or information that indicates an accuracy of the AI/ML model.

In some embodiments, providing the feedback about the AI/ML model to the network node comprises training (910A) the AI/ML model based at least in part on the RA procedure and the one or more adapted parameters to obtain an updated version of the AI/ML model.

In some embodiments, providing the feedback about the AI/ML model to the network node further comprises:
providing (91013), to the network node:
   (a) the updated version of the AI/ML model;
   (b) data descriptive of updates to the AI/ML model included in the updated version of the AI/ML model;
   (c) the set of input parameters; or
   (d) instructions to perform the updates to the AI/ML model included in the updated version of the AI/ML model.

In some embodiments, the set of input parameters of the AI/ML model comprise:
a) a frequency of a cell on which the RA procedure is to be performed;
b) a cell Identifier (ID) of the cell on which the RA procedure is to be performed;
c) a Tracking Area Code (TAC) of the cell on which the RA procedure is to be performed;
d) a Public Land Mobile Network (PLMN) ID of a PLMN of the cell on which the RA procedure is to be perform;
e) set of the beams to be used to perform the RA procedure;
f) cell and/or beam level measurements of a serving cell of the WCD;
g) cell and/or beam level measurements of the cell in which the RA procedure is to be performed;
h) a Random Access Channel (RACH) transmission power level to be used for the RA procedure (e.g., for an initial preamble transmission);
i) cell and/or beam level measurements of one or more inter-frequency neighboring cells and/or one or more intra-frequency neighboring cells of the WCD;
j) measurement of uplink resources used by the WCD;
k) interference measurement(s) performed by a radio unit of a serving cell of the WCD and/or by a radio unit of one or more neighboring cells of the WCD;
l) a timing advance of the WCD;
m) location information for the WCD;
n) absolute time information or relative time information for the WCD;
o) Minimization of Derive Test (MDT) measurements;
p) a power ramping value associated with the WCD;
q) any or all possible RACH configuration parameters in different RATs that are available;
r) a RACH report from the WCD; or
s) a combination of any two or more of (a)-(r).

In some embodiments, the one or more output parameters of the AI/ML model comprise:
i) an estimated success or failure of the RA procedure given values for the set of input parameters;
ii) a success probability of the RA procedure given the values of the set of input parameters;
iii) a failure probability of the RA procedure given the values of the set of input parameters;
iv) a probability of having a successful random access on a first random access attempt of the RA procedure;
v) a probability of having a successful random access in multiple attempts of the RA procedure;
vi) a probability of successful random access after a defined number of random access attempts of the RA procedure;
vii) a prediction of an actual number of random access attempts for successful random access;
viii) a prediction of a number of random access attempts for a given success probability;
ix) an actual RACH transmission power to be used for the RA procedure; or
x) a combination of any two or more of (i)-(ix).

In some embodiments, the one or more output parameters are either per beam or per cell.

In some embodiments, the one or more RA parameters comprise:
A. an initial power level to be used by the WCD to transmit an uplink signal including an initial preamble transmission for the RA procedure, wherein the initial power level comprises a per beam initial power level and/or a per cell initial power level);
B. a Modulation and Coding Scheme (MCS) used for transmission of message 3 or message 5 in a 4-step RACH procedure;
C. a MCS used for Physical Uplink Shared Channel (PUSCH) resources in a 2-step RACH procedure;
D. power ramping step per beam,
E. maximum number of random access attempts (i.e., maximum number of preamble transmissions);
F. a set of beams to be used by the WCD for the RA procedure;
G. a decision on whether to perform a 2-step RACH procedure or a 4-step RACH procedure; or
H. a combination of any two or more of A-G.

In some embodiments, adapting the one or more RA parameters for the RA procedure based on the AI/ML model comprises:
obtaining a first set of values for the set of input parameters based on a first set of values for the one or more RA parameters;
feeding the first set of values for the set of input parameters into the AI/ML model;
obtaining a set of values for the set of output parameters output by the AI/ML model responsive to the first set of values for the set of input parameters;
determining whether adaptation of at least one of the one or more RA parameters is needed based on the set of values for the set of output parameters output by the AI/ML model; and
upon determining that adaptation is needed, changing at least one of the first set of values for the one or more RA parameters to provide a second set of values for the one or more RA parameters.

In some embodiments, adapting the one or more RA parameters for the RA procedure based on the AI/ML model further comprises:
obtaining a second set of values for the set of input parameters based on the second set of values for the one or more RA parameters;
feeding the second set of values for the set of input parameters into the AI/ML model;
obtaining a second set of values for the set of output parameters output by the AI/ML model responsive to the second set of values for the set of input parameters;
determining whether adaptation of at least one of the one or more RA parameters is needed based on the second set of values for the set of output parameters output by the AI/ML model; and
upon determining that adaptation is needed, changing at least one of the second set of values for the one or more RA parameters to provide a third set of values for the one or more RA parameters.

In some embodiments, the method further comprises receiving, from the network node, information that defines a validity area for the AI/ML model, wherein adapting the one or more RA parameters for the RA procedure based on the AI/ML model comprises adapting the one or more RA parameters for the RA procedure based on the AI/ML model while the WCD is within the validity area defined for the AI/ML model.

In some embodiments, the method further comprises sending, to the network node, information that indicates a capability of the WCD to execute the AI/ML model.

In some embodiments, the AI/ML model is previously trained based at least in part on previously obtained WCD capability information.

In some embodiments, the method further comprises:
receiving, from the network node, instructions to execute the AI/ML model using a certain configuration to obtain an additional set of output parameters;
executing the AI/ML model using the certain configuration to obtain the additional set of output parameters; and
providing, to the network node, the additional set of output parameters.

In some embodiments, receiving the information from the network node comprises receiving (904A) the information about or that characterizes the AI/ML model that enables the WCD to build the AI/ML model that outputs the set of output parameters that represent whether the RA procedure to be performed by the WCD will be successful based on the set of input parameters, and building (904B) the AI/ML model based at least in part on the information.

In some embodiments, a WCD is proposed. The WCD is adapted to receive information from a network node, the information comprising an AI/ML model that outputs a set of output parameters that represent whether a RA procedure to be performed by the WCD will be successful based on a set of input parameters, or information about or that characterizes the AI/ML model that enables the WCD to build the AI/ML model that outputs the set of output parameters that represent whether the RA procedure to be performed by the WCD will be successful based on the set of input parameters. The WCD is adapted to adapt one or more RA parameters for the RA procedure based on the AI/ML model.

In some embodiments, a WCD is proposed. The WCD includes one or more transmitters, one or more receivers, and processing circuitry associated with the one or more transmitters and the one or more receivers. The processing circuitry is configured to cause the WCD to receive information from a network node, the information comprising an AI/ML model that outputs a set of output parameters that represent whether a RA procedure to be performed by the WCD will be successful based on a set of input parameters, or information about or that characterizes the AI/ML model that enables the WCD to build the AI/ML model that outputs the set of output parameters that represent whether the RA procedure to be performed by the WCD will be successful based on the set of input parameters. The processing circuitry is configured to cause the WCD to adapt one or more RA parameters for the RA procedure based on the AI/ML model.

In some embodiments, a non-transitory computer readable medium is proposed. The non-transitory computer readable medium includes instructions executable by processing circuitry of a wireless communication device (WCD) whereby the WCD is caused to receive information from a network node, the information comprising an AI/ML model that outputs a set of output parameters that represent whether a RA procedure to be performed by the WCD will be successful based on a set of input parameters, or information about or that characterizes the AI/ML model that enables the WCD to build the AI/ML model that outputs the set of output parameters that represent whether the RA procedure to be performed by the WCD will be successful based on the set of input parameters. The WCD is caused to adapt one or more RA parameters for the RA procedure based on the AI/ML model.

In some embodiments, a computer program is proposed. The computer program comprises instructions which, when executed on at least one processor of a WCD, cause the at least one processor to receive information from a network node, the information comprising an AI/ML model that outputs a set of output parameters that represent whether a RA procedure to be performed by the WCD will be successful based on a set of input parameters, or information about or that characterizes the AI/ML model that enables the WCD to build the AI/ML model that outputs the set of output parameters that represent whether the RA procedure to be performed by the WCD will be successful based on the set of input parameters. The at least one processor is caused to adapt one or more RA parameters for the RA procedure based on the AI/ML model.

In some embodiments, a computer implemented method performed by a network node is proposed. The method includes obtaining an AI/ML model that outputs a set of output parameters that represent whether a RA procedure to be performed by a WCD will be successful based on a set of input parameters. The method includes sending information to another node, the information comprising the AI/ML model or information about or that characterizes the AI/ML model.

In some embodiments, the another node is another network node or the WCD.

In some embodiments, the set of input parameters of the AI/ML model comprise:
a) a frequency of a cell on which the RA procedure is to be performed;
b) a cell Identifier (ID) of the cell on which the RA procedure is to be performed;
c) a Tracking Area Code (TAC) of the cell on which the RA procedure is to be performed;
d) a Public Land Mobile Network (PLMN) ID of a PLMN of the cell on which the RA procedure is to be perform;
e) set of the beams to be used to perform the RA procedure;
f) cell and/or beam level measurements of a serving cell of the WCD;
g) cell and/or beam level measurements of the cell in which the RA procedure is to be performed;
h) a Random Access Channel (RACH) transmission power level to be used for the RA procedure (e.g., for an initial preamble transmission);
i) cell and/or beam level measurements of one or more inter-frequency neighboring cells and/or one or more intra-frequency neighboring cells of the WCD;
j) measurement of uplink resources used by the WCD;
k) interference measurement(s) performed by a radio unit of a serving cell of the WCD and/or by a radio unit of one or more neighboring cells of the WCD;
l) a timing advance of the WCD;
m) location information for the WCD;
n) absolute time information or relative time information for the WCD;
o) Minimization of Derive Test (MDT) measurements;
p) a power ramping value associated with the WCD;
q) any or all possible RACH configuration parameters in different RATs that are available;
r) a RACH report from the WCD; or
s) a combination of any two or more of (a)-(r).

In some embodiments, the one or more output parameters of the AI/ML model comprise:
i) an estimated success or failure of the RA procedure given values for the set of input parameters;
ii) a success probability of the RA procedure given the values of the set of input parameters;

iii) a failure probability of the RA procedure given the values of the set of input parameters;
iv) a probability of having a successful random access on a first random access attempt of the RA procedure;
v) a probability of having a successful random access in multiple attempts of the RA procedure;
vi) a probability of successful random access after a defined number of random access attempts of the RA procedure;
vii) a prediction of an actual number of random access attempts for successful random access;
viii) a prediction of a number of random access attempts for a given success probability;
ix) an actual RACH transmission power to be used for the RA procedure; or
x) a combination of any two or more of (i)-(ix).

In some embodiments, the one or more output parameters are either per beam or per cell.

In some embodiments, the one or more RA parameters comprise:
A. an initial power level to be used by the WCD to transmit an uplink signal including an initial preamble transmission for the RA procedure, wherein the initial power level comprises a per beam initial power level and/or a per cell initial power level);
B. a Modulation and Coding Scheme (MCS) used for transmission of message 3 or message 5 in a 4-step RACH procedure;
C. a MCS used for PUSCH resources in a 2-step RACH procedure;
D. power ramping step per beam,
E. maximum number of random access attempts (i.e., maximum number of preamble transmissions);
F. a set of beams to be used by the WCD for the RA procedure;
G. a decision on whether to perform a 2-step RACH procedure or a 4-step RACH procedure; or
H. a combination of any two or more of A-G.

In some embodiments, wherein the method further comprises sending, to the another node, information that defines a validity area for the AI/ML model.

In some embodiments, obtaining the AI/ML model comprises training (902A) the AI/ML model based at least in part on network data to apply one or more updates the AI/ML model.

In some embodiments, the network data comprises a predicted trajectory for the WCD, and the one or more updates to the AI/ML model comprise an updated validity area for the AI/ML model greater than the validity area.

In some embodiments, a network node is proposed. The network node is adapted to obtain an AI/ML model that outputs a set of output parameters that represent whether a RA procedure to be performed by a WCD will be successful based on a set of input parameters. The network node is adapted to send information to another node, the information comprising the AI/ML model or information about or that characterizes the AI/ML model.

In some embodiments, the network node is further adapted to perform the method of any of claims.

In some embodiments, a network node is proposed that includes one or more transmitters, one or more receivers, and processing circuitry associated with the one or more transmitters and the one or more receivers. The processing circuitry is configured to cause the network node to obtain an AI/ML model that outputs a set of output parameters that represent whether a RA procedure to be performed by a WCD will be successful based on a set of input parameters. The processing circuitry is configured to cause the network node to send information to another node, the information comprising the AI/ML model or information about or that characterizes the AI/ML model.

In some embodiments, a computer implemented method performed by a network node is proposed. The method includes obtaining an AI/ML model that outputs a set of output parameters that represent whether a RA procedure will be successful based on a set of input parameters. The method includes adapting one or more RA parameters for a RA procedure to be performed by a WCD based on the AI/ML model. The method includes sending the one or more adapted RA parameters to the WCD.

In some embodiments, the set of input parameters of the AI/ML model comprise:
a) a frequency of a cell on which the RA procedure is to be performed;
b) a cell Identifier (ID) of the cell on which the RA procedure is to be performed;
c) a Tracking Area Code (TAC) of the cell on which the RA procedure is to be performed;
d) a Public Land Mobile Network (PLMN) ID of a PLMN of the cell on which the RA procedure is to be perform;
e) set of the beams to be used to perform the RA procedure;

f) cell and/or beam level measurements of a serving cell of the WCD;
g) cell and/or beam level measurements of the cell in which the RA procedure is to be performed;
h) a Random Access Channel (RACH) transmission power level to be used for the RA procedure (e.g., for an initial preamble transmission);
i) cell and/or beam level measurements of one or more inter-frequency neighboring cells and/or one or more intra-frequency neighboring cells of the WCD;
j) measurement of uplink resources used by the WCD;
k) interference measurement(s) performed by a radio unit of a serving cell of the WCD and/or by a radio unit of one or more neighboring cells of the WCD;
l) a timing advance of the WCD;
m) location information for the WCD;
n) absolute time information or relative time information for the WCD;
o) MDT measurements;
p) a power ramping value associated with the WCD;
q) any or all possible RACH configuration parameters in different RATs that are available;
r) a RACH report from the WCD; or
s) a combination of any two or more of (a)-(r).

In some embodiments, the one or more output parameters of the AI/ML model comprise:
i) an estimated success or failure of the RA procedure given values for the set of input parameters;
ii) a success probability of the RA procedure given the values of the set of input parameters;
iii) a failure probability of the RA procedure given the values of the set of input parameters;
iv) a probability of having a successful random access on a first random access attempt of the RA procedure;
v) a probability of having a successful random access in multiple attempts of the RA procedure;
vi) a probability of successful random access after a defined number of random access attempts of the RA procedure;
vii) a prediction of an actual number of random access attempts for successful random access;
viii) a prediction of a number of random access attempts for a given success probability;
ix) an actual RACH transmission power to be used for the RA procedure; or
x) a combination of any two or more of (i)-(ix).

In some embodiments, the one or more output parameters are either per beam or per cell.

In some embodiments, the one or more RA parameters comprise:
A. an initial power level to be used by the WCD to transmit an uplink signal including an initial preamble transmission for the RA procedure (e.g., per beam or per cell);
B. a MCS used for transmission of message 3 or message 5 in a 4-step RACH procedure;
C. a MCS used for PUSCH resources in a 2-step RACH procedure;
D. power ramping step per beam,
E. maximum number of random access attempts (i.e., maximum number of preamble transmissions);
F. a set of beams to be used by the WCD for the RA procedure;
G. a decision on whether to perform a 2-step RACH procedure or a 4-step RACH procedure; or
H. a combination of any two or more of A-G.

In some embodiments, adapting the one or more RA parameters for the RA procedure based on the AI/ML model comprises:
obtaining a first set of values for the set of input parameters based on a first set of values for the one or more RA parameters;
feeding the first set of values for the set of input parameters into the AI/ML model;
obtaining a set of values for the set of output parameters output by the AI/ML model responsive to the first set of values for the set of input parameters;
determining whether adaptation of at least one of the one or more RA parameters is needed based on the set of values for the set of output parameters output by the AI/ML model;
upon determining that adaptation is needed, changing at least one of the first set of values for the one or more RA parameters to provide a second set of values for the one or more RA parameters.

In some embodiments, adapting the one or more RA parameters for the RA procedure based on the AI/ML model further comprises:
obtaining a second set of values for the set of input parameters based on the second set of values for the one or more RA parameters;
feeding the second set of values for the set of input parameters into the AI/ML model;
obtaining a second set of values for the set of output parameters output by the AI/ML model responsive to the second set of values for the set of input parameters;
determining whether adaptation of at least one of the one or more RA parameters is needed based on the second set of values for the set of output parameters output by the AI/ML model; and
upon determining that adaptation is needed, changing at least one of the second set of values for the one or more RA parameters to provide a third set of values for the one or more RA parameters.

In some embodiments, a network node is proposed. The network node is adapted to obtain an AI/ML model that outputs a set of output parameters that represent whether a RA procedure will be successful based on a set of input parameters. The network node is adapted to adapt one or more RA parameters for a RA procedure to be performed by a WCD based on the AI/ML model. The network node is adapted to send the one or more adapted RA parameters to the WCD.

In some embodiments, a network node is proposed. The network node includes processing circuitry. The processing circuitry is configured to cause the network node to obtain an AI/ML model that outputs a set of output parameters that represent whether a RA, procedure will be successful based on a set of input parameters. The processing circuitry is configured to cause the network node to adapt one or more RA parameters for a RA procedure to be performed by a WCD based on the AI/ML model. The processing circuitry is configured to cause the network node to send the one or more adapted RA parameters to the WCD.

In some embodiments, a non-transitory computer readable medium is proposed. The non-transitory computer readable medium comprises instructions executable by processing circuitry of a network node whereby the network node is caused to obtain an AI/ML model that outputs a set of output parameters that represent whether a RA, procedure will be successful based on a set of input parameters. The network node is caused to adapt one or more RA parameters for a RA procedure to be performed by a WCD based on the AI/ML model. The network node is caused to send the one or more adapted RA parameters to the WCD.

In some embodiments, a computer program is proposed. The computer program comprises instructions which, when executed on at least one processor of a network node, cause the at least one processor to obtain an AI/ML model that outputs a set of output parameters that represent whether a RA, procedure will be successful based on a set of input parameters. The at least one processor is caused to adapt one or more RA parameters for a RA procedure to be performed by a WCD based on the AI/ML model. The at least one processor is caused to send the one or more adapted RA parameters to the WCD.

In some embodiments, a carrier containing the computer program is proposed. The carrier is one of an electronic signal, an optical signal, a radio signal, or a computer readable storage medium.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is a figure reproduced from section 5.6.5 of Third generation Partnership Program (3GPP) Technical Specification (TS) 36.331 V16.2.1;

FIG. 2 illustrates an example plurality of beams capable of transmitting their own Synchronization Signal Block (SSB) distinguished by an SSB index;

FIG. 3 illustrates an example mapping between SSBs and Random Access (RA) occasions;

FIG. 4 illustrates a first example mapping of 2 SSBs per RA occasion;

FIG. 5 illustrates an example in which a User Equipment (UE) does not perform power ramping, but transmits a preamble with a same previously transmitted power when a new SSB/beam is selected;

FIG. 6 illustrates one example of a cellular communications system in which embodiments of the present disclosure may be implemented;

FIG. 7 illustrates one example of a system in which Artificial Intelligence (AI) or Machine Learning (ML) is utilized to optimize the random access procedure in accordance with embodiments of the present disclosure;

FIG. 8 illustrates the operation of the system in accordance with one embodiment of the present disclosure;

FIG. 9A illustrates the operation of the system in accordance with another embodiment of the present disclosure;

FIG. 9B illustrates the operation of the system to build the AI/ML model in accordance with some embodiments of the present disclosure;

FIG. 9C illustrates the operation of the system to train and provide the AI/ML model in accordance with some embodiments of the present disclosure;

FIG. 9D illustrates the operation of the system to utilize the AI/ML model without active participation in RA procedure accordance with some embodiments of the present disclosure;

FIG. 10 is a flow chart that illustrates the operation of a node to execute the AI/ML model and adapt one or more RA parameters based on the output of the AI/ML model in accordance with one embodiment of the present disclosure;

FIGS. 11 and 12 illustrate an example on which an AI/ML model validity area is transferred in addition to the AI/ML model or the information about the AI/ML model to the other network node or to the Wireless Communication Device (WCD);

FIG. 13 illustrates an example scenario in which the validity of the input layers of the AI/ML model can cover a smaller area in comparison to the final layers of the AI/ML model;

FIG. 14 is a schematic block diagram of a radio access node 1400 according to some embodiments of the present disclosure;

FIG. 15 is a schematic block diagram that illustrates a virtualized embodiment of the radio access node according to some embodiments of the present disclosure;

FIG. 16 is a schematic block diagram of the radio access node 1400 according to some other embodiments of the present disclosure;

FIG. 17 is a schematic block diagram of a WCD according to some embodiments of the present disclosure; and

FIG. 18 is a schematic block diagram of the WCD according to some other embodiments of the present disclosure.

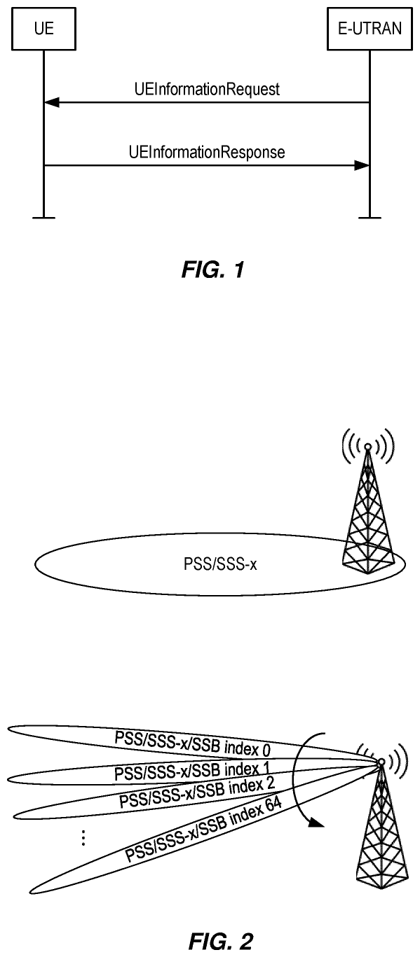

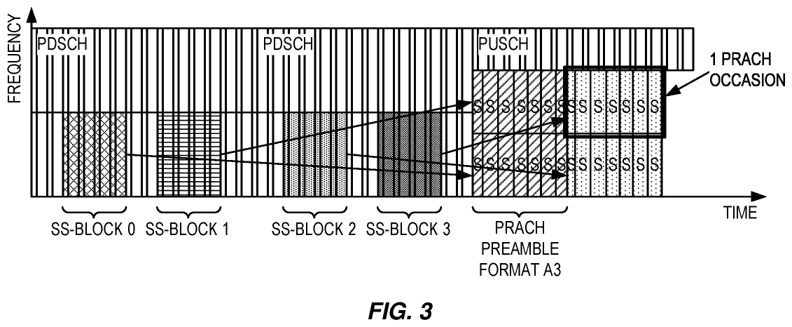

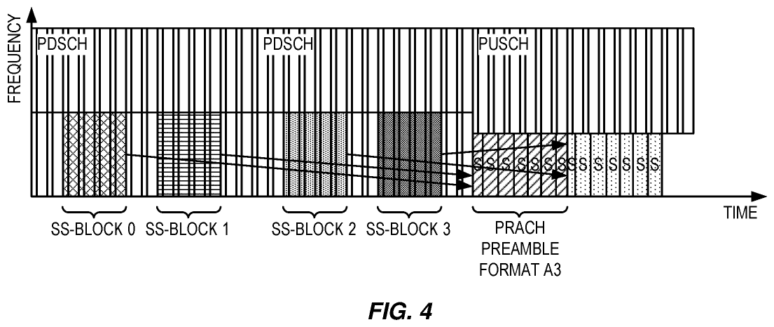

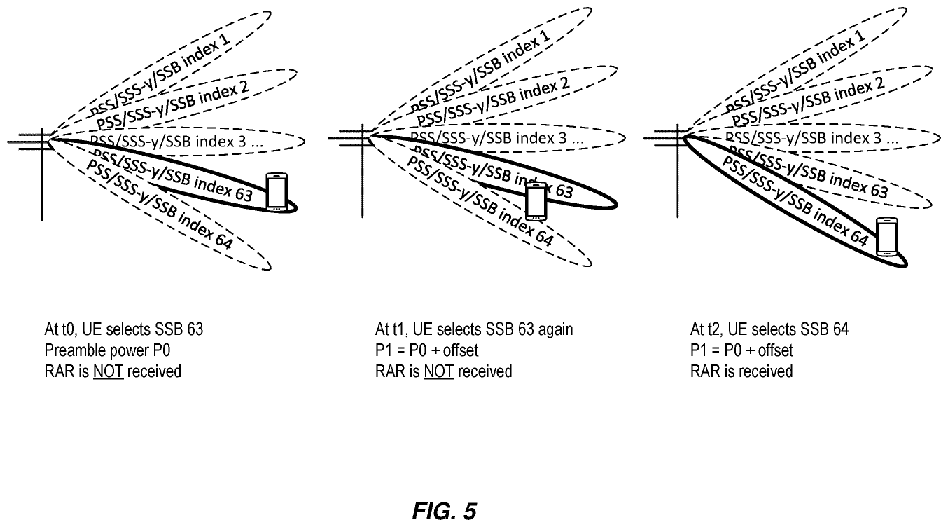

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

Certain aspects of the present disclosure and their embodiments may provide solutions to the aforementioned or other challenges.

Systems and methods are disclosed herein for optimizing a random access procedure based on a prediction of whether the random access procedure will be successful for a given set of input parameters. In the embodiments disclosed herein, this prediction is performed based on an Artificial Intelligence (AI) or Machine Learning (ML) model. In one embodiment, a computer-implemented method is provided in which an AI or ML model (denoted herein as “AI/ML model) is used to predict an outcome (i.e., success or failure) of the random access procedure in advance (i.e., prior to execution of the random access procedure) based on a set of input parameters (e.g., radio link quality and Random Access Channel (RACH) configuration used for that random access procedure). An output of the AI/ML model represents the predicted outcome of the random access procedure based on the set of input parameters. In one embodiment, the output of the AI/ML model is a parameter(s) that indicate a predicted success or failure probability of the random access procedure. In one embodiment, the output of the AI/ML model used to tune, or adapt, at least one configuration parameter (i.e., at least one RACH configuration parameter) of the random access procedure before starting execution of the random access procedure at a respective wireless communication device (e.g., at a respective UE). In one embodiment, based on the output of the AI/ML model, a radio node (e.g., a RAN node or a wireless communication device) optimizes (e.g., adapts) at least one parameter related to the RACH configurations such as, for example, initial preamble transmission power level, preamble received target power, set of beams to be used for the RACH access, modulation and coding scheme for Message 3 transmission, or the like, or any combination thereof.

In one embodiment, the AI/ML model are trained by a network node (e.g., a RAN node such as a base station, gNB-DU, or gNB-CU) and executed by the same network node (or some other network node) to find the optimal configuration of the random access procedure that, based on the AI/ML model, makes that a random access procedure of a particular wireless communication device or a particular group of wireless communication devices successful. The optimal configuration for the random access procedure is sent from the RAN node to the wireless communication device, where the wireless communication device uses the optimal configuration for the random access procedure. In one embodiment, this method is used, e.g., in RRC_Connected mode, e.g., for handover procedure.

In another embodiment, the AI/ML model is trained by a network (e.g., a RAN node such as a base station, gNB-DU, or gNB-CU) and then downloaded to one or more wireless communication devices for execution. According to the output of the AI/ML model, a wireless communication device takes some action that tunes, or adapts, one or more parameters of the random access procedure (e.g., adapts one or more parameters of the random access procedure such that, based on the AI/ML model, the random access procedure is predicted to be successful, at least with a defined confidence level).
In this case, in one embodiment, characteristics of the AI/ML model (or the actual AI/ML model) as well as a geographic area in which the AI/ML model is valid are sent to the wireless communication device, e.g., as part of a dedicated signal or as part of a common configuration e.g., as part of system information.
In one embodiment, the model validity area is a set of cells, a PLMN, or a TAC in which the AI/ML model is valid.
In one embodiment, the wireless communication device indicates its capability to execute an AI/ML model for random access optimization to the network (e.g., to a RAN node).
In one embodiment, after executing the AI/ML model, the wireless communication device indicates any form of AI/ML model output (e.g., success/failure probability of the random access procedure) to the network.
In one embodiment, after executing the AI/ML model, the wireless communication device indicates an accuracy of the AI/ML model output to the network.

There are, proposed herein, various embodiments which address one or more of the issues disclosed herein. In one embodiment, a computer implemented method performed by a Wireless Communication Device (WCD) comprises receiving information from a network node, where the information comprises an AI/ML model that outputs a set of output parameters that represent whether a RA procedure to be performed by the WCD will be successful based on a set of input parameters or information about or that characterizes the AI/ML model that enables the WCD to build the AI/ML model. In one embodiment, the method further comprises adapting one or more RA parameters for the RA procedure based on the AI/ML model.

Corresponding embodiments of a WCD are also disclosed. In one embodiment, a WCD is adapted to receive information from a network node, where the information comprises an AI/ML model that outputs a set of output parameters that represent whether a RA procedure to be performed by the WCD will be successful based on a set of input parameters or information about or that characterizes the AI/ML model that enables the WCD to build the AI/ML model. In one embodiment, the WCD is further adapted to adapt, or tune, one or more RA parameters for the RA procedure based on the AI/ML model.

In another embodiment, a WCD comprise one or more transmitters, one or more receivers, and processing circuitry associated with the one or more transmitters and the one or more receivers. The processing circuitry is configured to cause the WCD to receive information from a network node, where the information comprises an AI/ML model that outputs a set of output parameters that represent whether a RA procedure to be performed by the WCD will be successful based on a set of input parameters or information about or that characterizes the AI/ML model that enables the WCD to build the AI/ML model. The processing circuitry is further configured to cause the WCD to adapt, or tune, one or more RA parameters for the RA procedure based on the AI/ML model.

Embodiments of a computer-implemented method performed by a network node are also disclosed. In one embodiment, a computer-implemented method performed by a network node comprises obtaining an AI/ML model that outputs a set of output parameters that represent whether a RA procedure to be performed by a WCD will be successful based on a set of input parameters. The method further comprises sending information to another node, where the information comprises the AI/ML model or information about or that characterizes the AI/ML model. In one embodiment, the another node is another network node. In another embodiment, the another node is a WCD.

Corresponding embodiments of a network node are also disclosed. In one embodiment, a network node is adapted to obtain an AI/ML model that outputs a set of output parameters that represent whether a RA procedure to be performed by a WCD will be successful based on a set of input parameters. The network node is further adapted to send information to another node, where the information comprises the AI/ML model or information about or that characterizes the AI/ML model. In one embodiment, the another node is another network node. In another embodiment, the another node is a WCD.

In another embodiment, a network node comprises processing circuitry (e.g., one or more processors and memory) configured to cause the network node to obtain an AI/ML model that outputs a set of output parameters that represent whether a RA procedure to be performed by a WCD will be successful based on a set of input parameters. The processing circuitry is further configured to cause the network node to send information to another node, where the information comprises the AI/ML model or information about or that characterizes the AI/ML model. In one embodiment, the another node is another network node. In another embodiment, the another node is a WCD.

In another embodiment, a computer-implemented method performed by a network node comprises obtaining an AI/ML model that outputs a set of output parameters that represent whether a RA procedure will be successful based on a set of input parameters, adapting one or more RA parameters for a RA procedure to be performed by a WCD based on the AI/ML model, and sending the one or more adapted RA parameters to the WCD.

Corresponding embodiments of a network node are also disclosed. In one embodiment, a network node is adapted to obtain an AI/ML model that outputs a set of output parameters that represent whether a RA procedure will be successful based on a set of input parameters, adapt one or more RA parameters for a RA procedure to be performed by a WCD based on the AI/ML model, and send the one or more adapted RA parameters to the WCD.

In another embodiment, a network node comprises processing circuitry configured to cause the network node to obtain an AI/ML model that outputs a set of output parameters that represent whether a RA procedure will be successful based on a set of input parameters, adapt one or more RA parameters for a RA procedure to be performed by a WCD based on the AI/ML model, and send the one or more adapted RA parameters to the WCD.

Certain embodiments may provide one or more of the following technical advantage(s). Embodiments of the present disclosure may assist the wireless network to predict the performance of the random access procedure in advance (before execution of the random access procedure) and may enable the possibility to optimize the random access configuration parameters to have a successful RACH transmission and avoid failure or additional delay caused by unwanted multiple preamble transmissions. In fact, the AI/ML model for random access optimization may help the wireless communication device to find the optimal random access configuration e.g., preamble transmission power to perform the random access procedure successfully on the first random access attempt, e.g., without causing unnecessary interference.

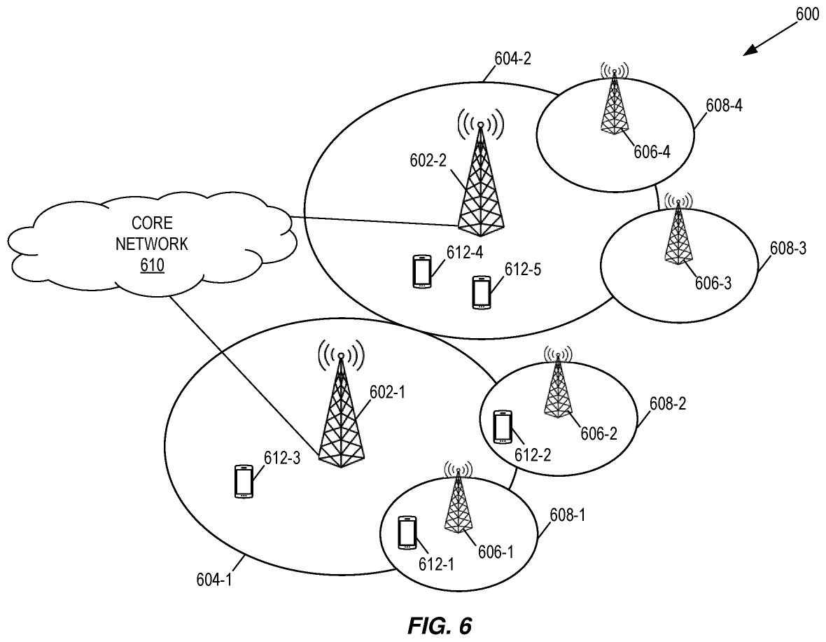

FIG. 6 illustrates one example of a cellular communications system 600 in which embodiments of the present disclosure may be implemented. In the embodiments described herein, the cellular communications system 600 is a 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC); however, the embodiments disclosed here can be used for other types of cellular or wireless networks in which random access is performed. In this example, the RAN includes base stations 602-1 and 602-2, which in the 5GS include NR base stations (gNBs) and optionally next generation eNBs (ng-eNBs) (e.g., LTE RAN nodes connected to the 5GC) and in the EPS include eNBs, controlling corresponding (macro) cells 604-1 and 604-2. The base stations 602-1 and 602-2 are generally referred to herein collectively as base stations 602 and individually as base station 602. Likewise, the (macro) cells 604-1 and 604-2 are generally referred to herein collectively as (macro) cells 604 and individually as (macro) cell 604. The RAN may also include a number of low power nodes 606-1 through 606-4 controlling corresponding small cells 608-1 through 608-4. The low power nodes 606-1 through 606-4 can be small base stations (such as pico or femto base stations) or Remote Radio Heads (RRHs), or the like. Notably, while not illustrated, one or more of the small cells 608-1 through 608-4 may alternatively be provided by the base stations 602. The low power nodes 606-1 through 606-4 are generally referred to herein collectively as low power nodes 606 and individually as low power node 606. Likewise, the small cells 608-1 through 608-4 are generally referred to herein collectively as small cells 608 and individually as small cell 608. The cellular communications system 600 also includes a core network 610, which in the 5GS is referred to as the 5GC and in the EPS is referred to as the EPC. The base stations 602 (and optionally the low power nodes 606) are connected to the core network 610.

The base stations 602 and the low power nodes 606 provide service to wireless communication devices 612-1 through 612-5 in the corresponding cells 604 and 608. The WCDs 612-1 through 612-5 are generally referred to herein collectively as WCDs 612 and individually as WCD 612. In the following description, the WCDs 612 are oftentimes UEs and as such are sometimes referred to as UEs 612.

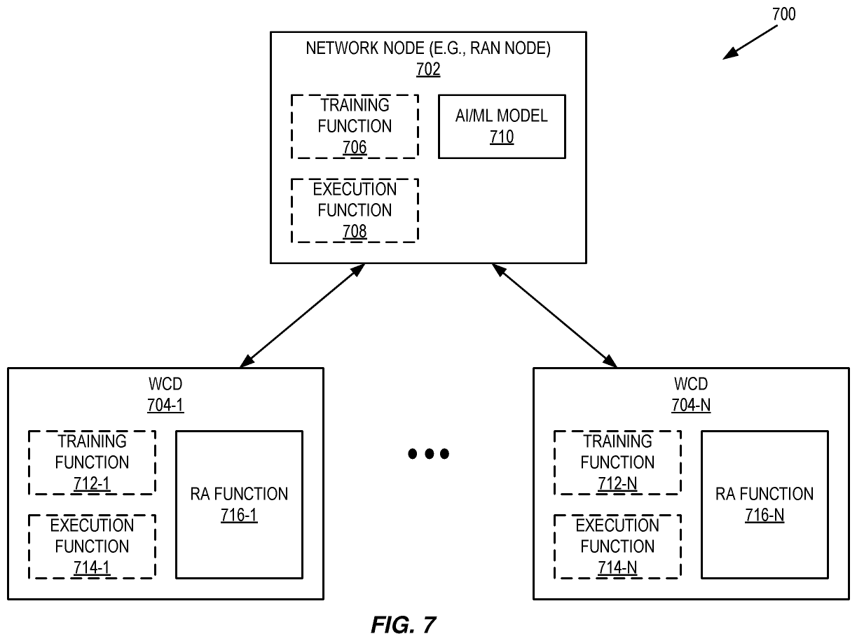

FIG. 7 illustrates one example of a system 700 in which AI or ML is utilized to optimize the random access procedure in accordance with embodiments of the present disclosure. Optional components are represented by dashed boxes. The system 700 includes a network node 702 and multiple wireless communication devices (WCDs) 704-1 through 704-N. In one particular embodiment, the system 700 is implemented within the cellular communications system 600 of FIG. 6 where the network node 702 is a RAN node such as the base station 602 or a RAN node that implements part of the functionality of the base station 602 (e.g., a gNB-DU or a gNB-CU) and the WCDs 704-1 through 704-N include at least a subset of the WCDs 612.

As illustrated, the network node 702 includes a training function 706 (optional) and an execution function 708 (optional). The network node 702 obtains and stores (at least temporarily) an AI/ML model 710 that is trained to provide a set of output parameters that represent a prediction of whether a random access procedure will be successful or fail based on a set of input parameters. The details of the input and output parameters are provided below. Each WCD 704 includes a training function 712 (optional), an execution function 714 (optional), and a random access (RA) function 716 that operates to perform a random access procedure based on one or more RA parameter(s) that have been adapted (e.g., optimized) using the AI/ML model 710.

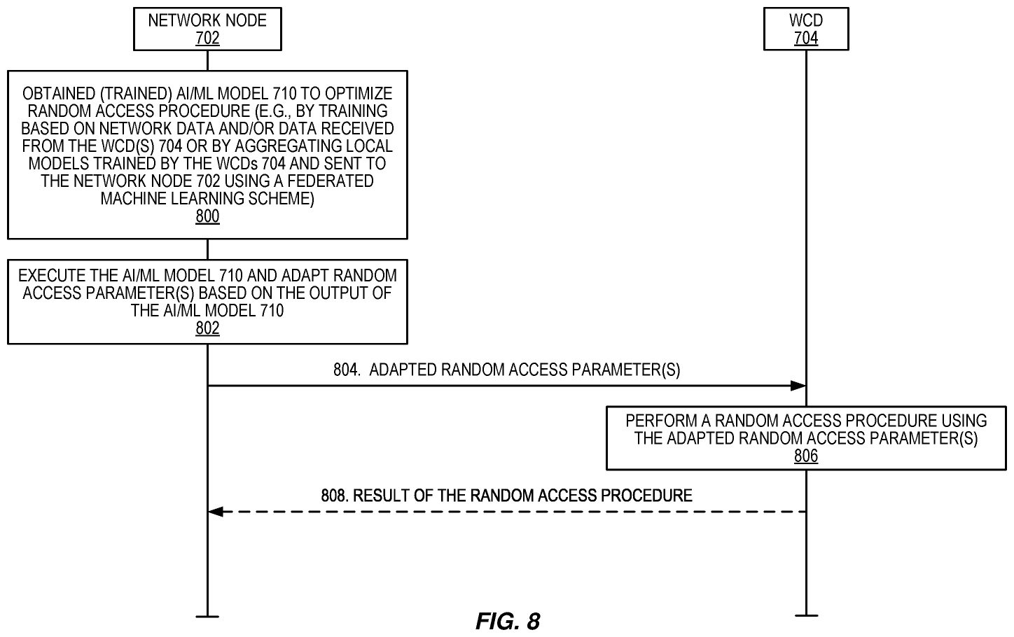

FIG. 8 illustrates the operation of the system 700 in accordance with one embodiment of the present disclosure. Optional steps are represented by dashed lines/boxes. As illustrated, the network node 702 obtains the AI/ML model 710 (step 800). The network node 702 obtains the AI/ML model 710 as a result of a training procedure. Training of the AI/ML model 710 can be done using any type of AI or ML training procedure. In one example embodiment, in step 710, the training function 706 at the network node 702 trains the AI/ML model 710 based on network data (i.e., data available to the network node 702) and/or WCD data (i.e., data provided to the network node 702 from the WCDs 704). In another example embodiment, a federated machine learning procedure is used to train the AI/ML model 710. As will be understood by those of ordinary skill in the art of machine learning, when using a federated machine learning procedure, the training functions 712 at the WCDs 704 train local versions of the AI/ML model 710 based on local data (i.e., data available to the WCDs 704 (e.g., data indicative of RA procedure, input(s) of the model, output(s) of the model, etc.)) and send their local models to the network node 702 (e.g., an updated (or otherwise trained) version of the AI/ML model, data descriptive of updates included in the updated version of the AI/ML model, input/output parameter(s), instructions to perform the updates to the AI/ML model included in the updated version, etc.). Then, in step 800, the network node 702 obtains the AI/ML model 710 by aggregating, or combining, the local models to provide the AI/ML model 710. Other types of AI or ML training procedures may be used. Regardless of the training procedure uses, the network node 702 obtains the AI/ML model 710.

In this embodiment, the execution function 708 at the network node 702 executes the AI/ML model 710 and adapts one or more random access parameters for the WCD 704 (or for a set of WCDs 704 including the WCD 704) based on the output of the AI/ML model 710 (step 802). More specifically, in one embodiment, the execution function 708 feeds values for the set of input parameters into the AI/ML model 710, where these values are specific to the WCD 704 (or the set of WCDs 704) for which the RA parameters are being adapted. In response, the AI/ML model 710 outputs values for the set of output parameters that represent a prediction of whether the RA procedure will succeed or fail based on the values of the input parameters. If the RA procedure is predicted to fail, then at least one of the RA parameters is changed. This process is repeated until the RA parameter(s) are adapted such that the AI/ML model 710 predicts that the RA procedure will succeed.

The network node 702 sends the adapted RA parameter(s) to the WCD 704 (step 804). The RA function 716 at the WCD 704 performs the RA procedure using the adapted RA parameter(s) (step 806). Optionally, the WCD 704 sends a result of the RA procedure (i.e., success or failure) to the network node 702, where this result may be used for further training of the AI/ML model 710 (step 808).

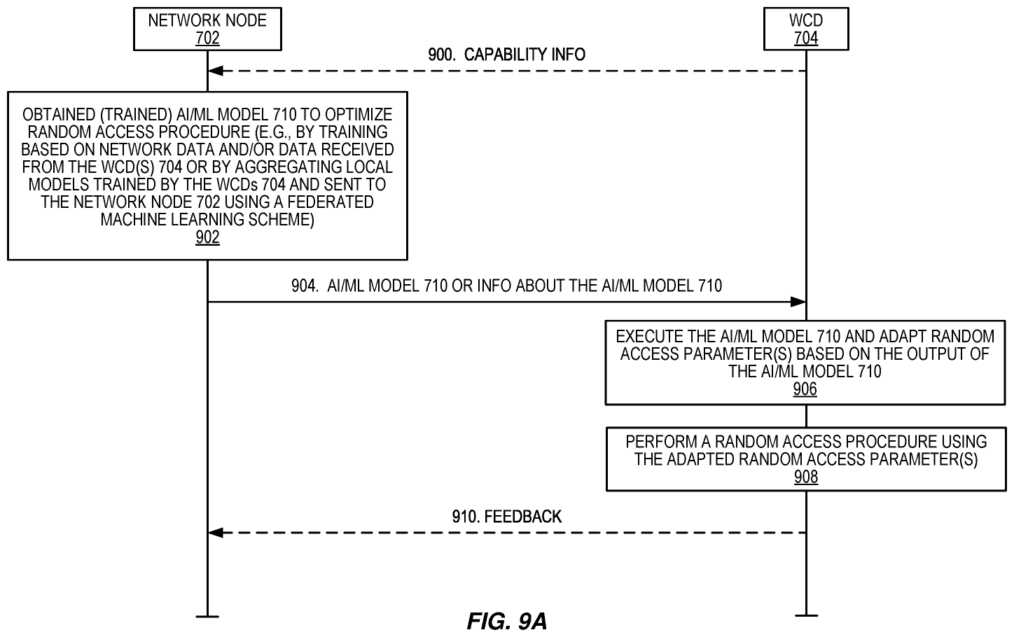

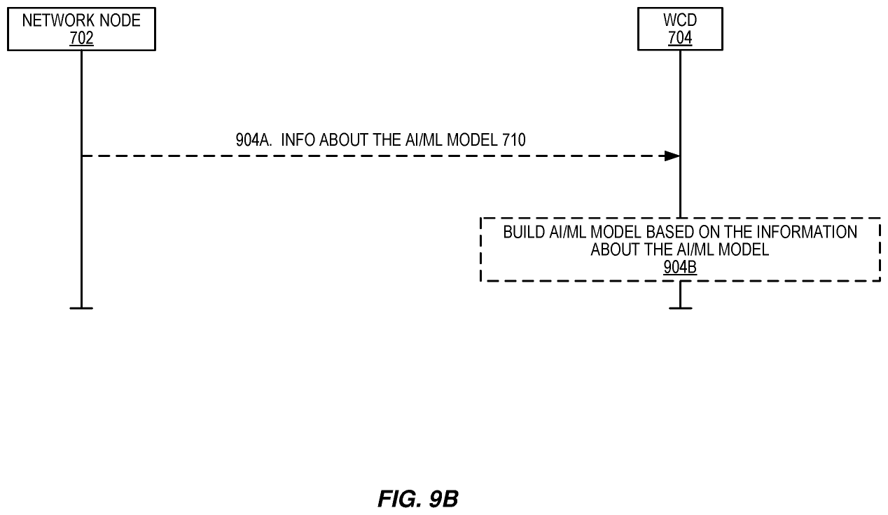

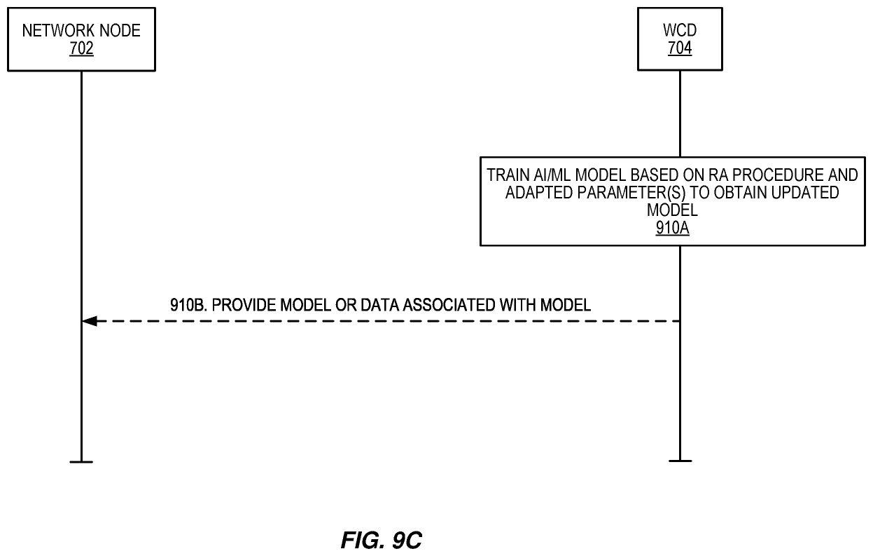

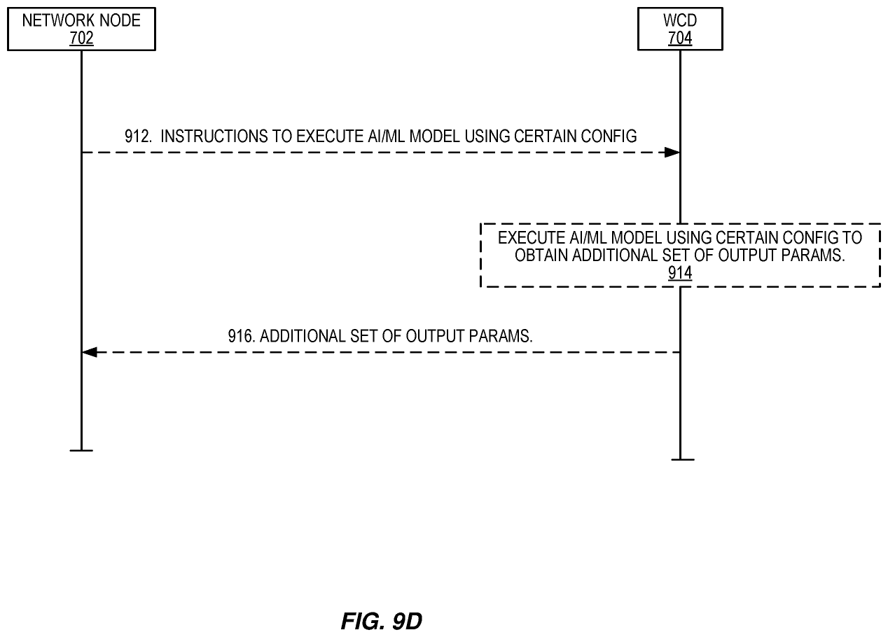

FIG. 9A illustrates the operation of the system 700 in accordance with another embodiment of the present disclosure. Optional steps are represented by dashed lines/boxes. As illustrated, WCD 704 optionally sends capability information to the network node 702 (step 900). This capability information includes information that explicitly or implicitly indicates that the WCD 704 is capable of executing the AI/ML model 710 for RA optimization. The network node 702 obtains the AI/ML model 710 in the same manner as described above with respect to step 800 of FIG. 8 (step 902).

In this embodiment, the network node 702 sends the AI/ML model 710 or information about or otherwise characterizes the AI/ML model 710 (e.g., neural network neuron weights) to the WCD 704 (e.g., the AI/ML model that outputs the set of output parameters that represent whether the RA procedure to be performed by the WCD will be successful based on the set of input parameters) (step 904). For example, FIG. 9B illustrates the operation of the system 700 to build the AI/ML model in accordance with some embodiments of the present disclosure. Turning to FIG. 9B, at step 904A, in some embodiments, the WCD 704 receives, from the network node 702, the information about or that characterizes the AI/ML model 710. This information enables the WCD 704 to build the AI/ML model 710 that outputs the set of output parameters that represent whether the RA procedure to be performed by the WCD 704 will be successful based on the set of input parameters. At step 904B, the WCD builds the AI/ML model based at least in part on the information.

Returning to FIG. 9A, the execution function 714 at the WCD 704 executes the AI/ML model 710 and adapts one or more random access parameters for the WCD 704 based on the output of the AI/ML model 710 (step 906). More specifically, in one embodiment, the execution function 714 feeds values for the set of input parameters into the AI/ML model 710, where these values are specific to the WCD 704 for which the RA parameters are being adapted. In response, the AI/ML model 710 outputs values for the set of output parameters that represent a prediction of whether the RA procedure will succeed or fail based on the values of the input parameters. If the RA procedure is predicted to fail, then at least one of the RA parameters is changed. This process is repeated until the RA parameter(s) are adapted such that the AI/ML model 710 predicts that the RA procedure will succeed.

The RA function 716 at the WCD 704 performs the RA procedure using the adapted RA parameter(s) (step 908). Optionally, the WCD 704 sends a feedback to the network node 702, where this feedback may be used for further training of the AI/ML model 710 (step 910). In one embodiment, the feedback includes an output of the AI/ML model 710 and/or information that indicates an accuracy of the AI/ML model 710. As an example, FIG. 9C illustrates the operation of the system 700 to train and provide the AI/ML model in accordance with some embodiments of the present disclosure. Turning to FIG. 9C, at step 910A, in some embodiments, the WCD 704 trains the AI/ML model 710 based at least in part on the RA procedure and the one or more adapted parameters to obtain an updated version of the AI/ML model 710. At step 91013, in some embodiments, to provide the feedback about the AI/ML model 710 to the network node 704, the WCD 704 provides to the network node 704: (a) the updated version of the AI/ML model 710, (b) data descriptive of updates to the AI/ML model 710 included in the updated version of the AI/ML model 710, (c) the set of input parameters, or (d) instructions to perform the updates to the AI/ML model included in the updated version of the AI/ML model.

Returning to FIG. 9A, in some embodiments, the AI/ML model may be utilized without participation in RA procedure. As an example, FIG. 9D illustrates the operation of the system 700 to utilize the AI/ML model 710 without active participation in RA procedure accordance with some embodiments of the present disclosure. Turning to FIG. 9D, at step 912, in some embodiments, the WCD 704 receives, from the network node 702, instructions to execute the AI/ML model using a certain configuration to obtain an additional set of output parameters. At step 914, in some embodiments, the WCD 704 executes the AI/ML model using the certain configuration to obtain the additional set of output parameters. At step 916, in some embodiments, the WCD 704 provides, to the network node 702, the additional set of output parameters.

Now, some details of some example embodiments relating to various aspects of the present disclosure will be provided.

### AI/ML Model Training for RACH Optimization (RO): Input and Output

As discussed above, the AI/ML model 710 has a set of input parameters and a set of output parameters and is executed either by the network node 702 or the WCD 704 to predict the outcome (i.e., success or failure) of the random access procedure in advance (i.e., before the random access procedure is actually performed by the WCD 704) based on the set of input parameters. The output of the AI/ML model 710 is used to tune, or adapt, the one or more RA parameters (e.g., one or more RACH configuration parameters) before starting the actual random access procedure. The one or more random access parameters that are adapted (e.g., optimized) based on the output of the AI/ML model 710 may include, for example, initial preamble transmission level, preamble received target power, set of beams to be used for the RACH access, modulation, and coding scheme for message 3 transmission, or the like, or any combination thereof.

In one embodiment, the set of input parameters of the AI/ML model 710 includes one or more of the following parameters:
frequency of the cell on which the random access procedure is to be performed,
cell ID of the cell on which the random access procedure is to be performed, where the cell ID may include physical cell ID and global cell ID, TAC, PLMN identity, etc.,
set of the beams selected to be used to perform the random access procedure,
cell and/or beam level measurements of the serving cell,
cell and/or beam level measurements of the cell in which the random access procedure is to be performed,
RACH transmission power level to be used, e.g., for the initial preamble transmission,
cell and/or beam level measurement of the inter-frequency neighboring cells and/or intra-frequency neighboring cells,
measurement of the uplink resources used by the WCD 704 (or WCDs 704) e.g., Sounding Reference Signal—SRS measurements,
interference measurement performed by the radio unit of the serving cell and/or that of the neighboring cells,
timing advance, when available,
location information,
time (either absolute or relative time) information,
Minimization of Derive Test (MDT) measurements,
power ramping value,
any or all possible RACH configuration parameters in different RAT technologies such as LTE and NR available (see, e.g., RRC TS 38.331 and TS 36.331),
RACH report from the WCD 704.

The set of output parameters of the AI/ML model 710 may comprise one or more of the following parameters:
estimated success (e.g., success or failure, which may be represented as logical 1 or logical 0) of the random access procedure given values for the set of input parameters,
success probability of the random access procedure given the values of the set of input parameters,
failure probability of random access procedure given the values of the set of input parameters,
probability of having a successful random access on a first random access attempt,
probability of having a successful random access in multiple attempts,
probability of successful random access after some defined number of attempts,
prediction of the actual number of random access attempts for successful random access,
prediction of the number of RACH attempts for a given success probability.

The above output parameters can be per beam or can be per cell. In other words, for example, the set of output parameters of the AI/ML model 710 can be a probability of a successful RA procedure if a set of at least one specific beam is selected by the WCD 704 for the RA procedure.

In one embodiment, the set of output parameters comprises the actual RACH power to be used in the RACH transmission by the WCD 704. In this case, the RACH related power parameters are not fed to the model input.

### Adaptation of RA Parameter(s)

As discussed above, depending on the particular embodiment, either the network node 702 or the WCD 704 uses the output of the AI/ML model 710 to tune one or more RA parameters. In one embodiment, these one or more RA parameters include one or more of the following parameters:
initial power level to be used by the WCD 704 to transmit an uplink signal including the preamble transmission,
   initial power level can be per beam initial power level or can be per cell initial power level or can be a combination of both,
Modulation and Coding Scheme (MCS) of transmission of message 3 or message 5 in a 4-step RACH procedure, or the MCS used for PUSCH resources in 2-step RACH procedure,
power ramping step per beam,
maximum number of random access attempts i.e. maximum number of preamble transmissions,
set of beams to be used by the WCD 704 for the RA procedure,
decision on whether to perform 2-step RACH or 4-step RACH procedure.
   Note, however, that the RA parameters above are only examples. Many other RA related parameters will be apparent to those of ordinary skill in the art. Thus, to be clear, RA parameter(s) in addition to or as an alternative to any combination of one or more of the example RA parameters given above may be tuned based on the AI/ML model 710.

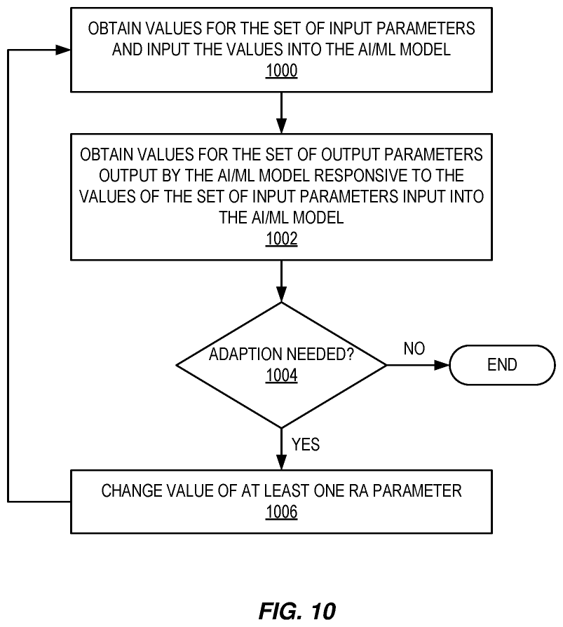

For this tuning, the network node 702 or the WCD 704 updates the values for the set of input parameters based on the taken action (i.e., based on the changed RA parameter(s)), feeds the updated values for the set of input parameters to the AI/ML model 710, and run the AI/ML model 710 again. This process is repeated until the output of the AI/ML model 710 indicates that the RA procedure will be successful, at least with a certain probability. A non-limiting example of model execution by a node (i.e., the network node 702 or the WCD 704) is shown in FIG. 10.

FIG. 10 is a flow chart that illustrates the operation of a node to execute the AI/ML model 710 and adapt one or more RA parameters based on the output of the AI/ML model 710 in accordance with one embodiment of the present disclosure. This procedure may be performed by the network node 702 (e.g., in step 802 of FIG. 8) or by the WCD 704 (e.g., in step 906 of FIG. 9). The steps of this process are as follows.

Step 1000: The node obtains values for the set of input parameters of the AI/ML model 710 and inputs the obtained values into the AI/ML mode 710. These values of the set of input parameters values that are applicable to the WCD 704 for which the RA parameter(s) is(are) to be tuned.

Step 1002: The node obtains the values of the set of output parameters output by the AI/ML model 710 responsive to the values of the set of input parameters input into the AI/ML model 710 in step 1000.

Step 1004: The node determines, based on the values of the set of output parameters of the AI/ML model 710 obtained in step 1002, whether adaptation of the RA parameter(s) is needed. For example, the node may determine whether a failure probability for the RA procedure is above a defined (e.g., predefined or configured) failure threshold. Adaptation is needed if the failure probability is greater than the threshold. The decision in this step can be performed based on any output parameter or any combination of output parameters described above (e.g., success probability, success probability at first RACH attempt, or any etc.).

Step 1006: If adaptation is needed, then the node changes at least one of the RA parameters and the process returns to step 1000 and is repeated. Note that the obtained values for the set of input parameters of the AI/ML model 710 in step 1000 are updated based on the change made in step 1006.

Once no further adaptation is needed (i.e., once the AI/ML model 710 predicts successful RA procedure), the process ends.

### Signaling Among Different Network Entities (RAN Nodes and WCDs)

The AI/ML model 710 (or characteristics and information to be used to build the AI/ML model 710) can be signaled between different RAN nodes such as gNBs, gNB-DU, gNB-CU, eNB, operation and maintenance unit (OAM), etc.

In one embodiment, in a RAN split architecture, the AI/ML model 710 is trained at gNB-DU and then forwarded to the gNB-CU of the RAN node over e.g., F1 interface. Note that characteristics and information (e.g., neural network neuron weights, activation functions, and/or the like) to be used to build the AI/ML model 710 can be forwarded instead of the actual AI/ML model 710.

In another embodiment, in a RAN split architecture, the AI/ML model 710 is trained at gNB-CU and then forwarded to the gNB-DU of the RAN node over e.g., F1 interface. Note that characteristics and information to be used to build the AI/ML model 710 can be forwarded instead of the actual AI/ML model 710.

In another embodiment, the trained AI/ML model 710 is transferred between two RAN nodes over X2 or Xn interface. Note that characteristics and information to be used to build the AI/ML model 710 can be forwarded instead of the actual AI/ML model 710.

In another embodiment, the trained AI/ML model 710 is transferred between two RAN nodes over NG interface and via the core network. Note that characteristics and information to be used to build the AI/ML model 710 can be forwarded instead of the actual AI/ML model 710.

In yet another embodiment, the trained AI/ML model 710 can be sent to the WCD 704 over wireless radio interfaces. The AI/ML model 710 can be transmitted in a unicast transmission to the WCD 704, for example, over RRC. This can be useful in an embodiment when the AI/ML model 710 is created on a per-WCD basis (e.g., one AI/ML model 710 for each WCD manufacturer). The network (e.g., the network node 702) can then create an AI/ML model 710 that learns hardware impairments for different WCDs 104. In case an AI/ML model 710 is valid for a number of WCDs 104, the AI/ML model 710 can be signaled in a broadcasted transmission, e.g. in SIB. Note that characteristics and information to be used to build the AI/ML model 710 can be forwarded instead of the actual AI/ML model 710.

In another embodiment, the WCD 704 trains the AI/ML model 710 and sends, to the network (e.g., to the network node 702), an updated version of the AI/ML model 710 or the weights of the AI/ML model 710. In this case, the network can receive instructions on how the AI/ML model 710 should be updated. For example, in case of neural networks, these instructions may include the learning rate used and which optimizer to use (ADAM optimizer for instance). An update can include only a delta indicating the differences of the updated AI/ML model 710 versus the old AI/ML model 710. For such updating, the network can indicate a threshold delta value(s), comprising the thresholds for when to include a certain weight in order to reduce signaling. The WCD 704 could, in another embodiment, signal the gradient of the AI/ML model 710 used for backpropagation in NN. The WCD 704 could, in another embodiment, signal the actual data that generated/not-generated a RACH success.

In yet another embodiment, the WCD 704 sends an indication to the network (e.g., to the network node 702) indicating its capability on executing the AI/ML model 710. The indication can include its available memory and which types of AI/ML model types it supports. In one embodiment, the AI/ML model 710 is a type of AI/ML mode supported by the WCD 704 based on the received WCD capabilities.

In yet another embodiment, the WCD 704, upon executing the AI/ML model 710 and performing the RACH procedure, logs and reports the outcome of the AI/ML model 710 to the network (e.g., to the network node 702) as part of a WCD reported information such as, e.g., a RACH report, a RLF report, a successful handover report, or DC related failure information.

In yet another embodiment, even if the WCD 704 does not have any RACH to perform, the network (or a RAN node) serving the WCD 704, instructs the WCD 704 to execute the AI/ML model 710 with a certain configuration (or with a default configuration) and ask the WCD 704 to send at least one of the outputs of the AI/ML model 710 to the network.

The output of the AI/ML model 710 can be per beam or a set of beams. The WCD 704 can indicate to the network the RACH configuration and the set of the beams that have been used as input to run the AI/ML model 710.

In yet another embodiment, the WCD 704 sends a report to the network indicating the accuracy of the AI/ML model output. The accuracy measurement can be later used by network to tune the AI/ML model 710.

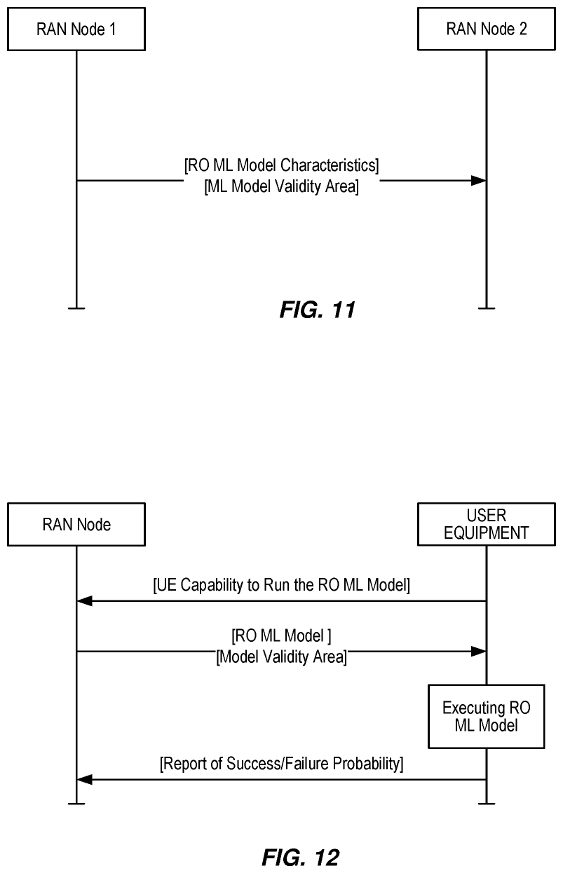

In all the above-mentioned embodiments, an AI/ML model validity area can be transferred in addition to the AI/ML model 710 or the information about the AI/ML model 710 to the other network node or to the WCD 704, as illustrated in FIGS. 11 and 12. In one embodiment, the AI/ML model validity area indicates a list of the entities in which the AI/ML model 710 is valid to be re-trained or executed. The AI/ML model validity area can comprise at least one of the following parameters:
List of cells including the physical cell ID or global cell ID,
List of frequencies identified by e.g., EARFCN,
List of RAN nodes IDs,
Time-window when the model is valid,
Geographical area when the model is valid,
List of UEs with specific UE identifier e.g., International Mobile Subscriber Identity (IMSI) or TIMSI.

The AI/ML model validity area indicates in which network entities (including the cells) the AI/ML model 710 can be executed or re-trained. Hence, the node receiving the AI/ML model 710 is aware where to use the AI/ML model 710.

In one embodiment, one can use a predicted trajectory of the WCD 704 in order to train a model that is valid for a larger area. For example, the serving node can receive training data from future nodes expected to be serving the WCD 704 and build a model that is valid in a larger area. The serving node can, in another embodiment receive, the AI/ML model for the future nodes and signal multiple models to the WCD 704, in order for the WCD 704 to be prepared for a RA in the predicted future nodes. In other words, if the network data includes a predicted trajectory for the WCD 704, the network node (e.g., network node 702) can train the AI/ML model based at least in part on the network data to apply an updated validity area for the AI/ML model that is greater than a validity area that is currently for the AI/ML model.

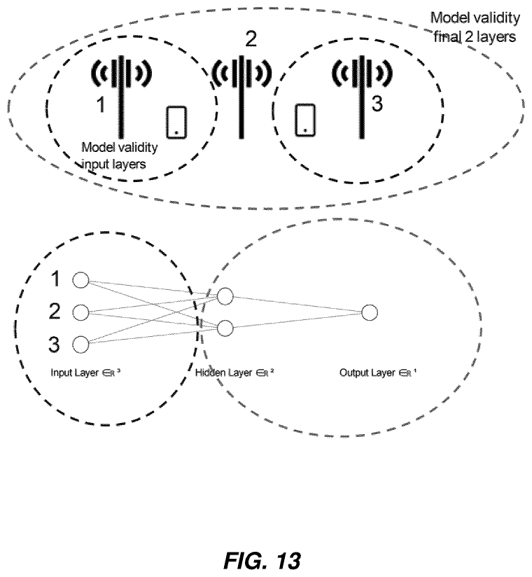

In another embodiment, the AI/ML model 710 is partly valid, for a sub-model-level area. The AI/ML model 710 can have, in case of a neural network, a number of general layers in the end. In one embodiment, these general layers could comprise two or more neural network layers for translating a success probability to a binary value (I/O). In this case, the validity of the input layers can cover a smaller area in comparison to the final layers, exemplified in FIG. 13. One scenario where such can in particular be useful is in homogeneous deployments such as, for example, that illustrated in FIG. 13, where the WCD 704 is expected to have similar characteristics to its strongest node, 2^{nd} strongest node, and 3^{rd} strongest node. However, the input layer weights need to be changed based on the WCD serving cell (1 or 3) in order to include this homogeneity, since the input features of the node does not change (e.g., node 1 is at the top of the input layer). One could in one example have the first layer to activate (non-zero) weights for cell 1 respectively cell 3 depending on the UE serving cell.

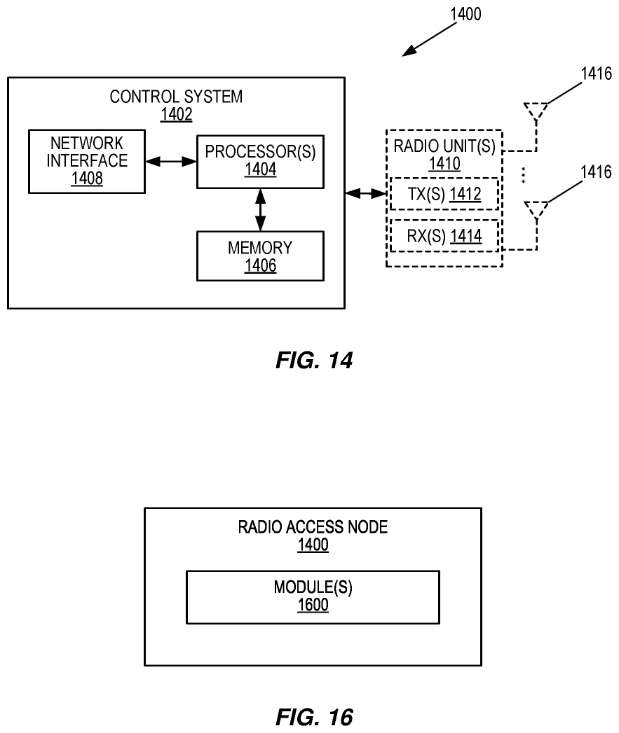

FIG. 14 is a schematic block diagram of a radio access node 1400 according to some embodiments of the present disclosure. Optional features are represented by dashed boxes. The radio access node 1400 may be, for example, a base station 602 or 606 or a network node that implements all or part of the functionality of the base station 602 or gNB described herein. As illustrated, the radio access node 1400 includes a control system 1402 that includes one or more processors 1404 (e.g., Central Processing Units (CPUs), Application Specific Integrated Circuits (ASICs), Field Programmable Gate Arrays (FPGAs), and/or the like), memory 1406, and a network interface 1408. The one or more processors 1404 are also referred to herein as processing circuitry. In addition, the radio access node 1400 may include one or more radio units 1410 that each includes one or more transmitters 1412 and one or more receivers 1414 coupled to one or more antennas 1416. The radio units 1410 may be referred to or be part of radio interface circuitry. In some embodiments, the radio unit(s) 1410 is external to the control system 1402 and connected to the control system 1402 via, e.g., a wired connection (e.g., an optical cable). However, in some other embodiments, the radio unit(s) 1410 and potentially the antenna(s) 1416 are integrated together with the control system 1402. The one or more processors 1404 operate to provide one or more functions of the radio access node 1400 as described herein (e.g., one or more functions of the network node 702, base station 602, gNB, gNB-CU, or gNB-DU, as described herein). In some embodiments, the function(s) are implemented in software that is stored, e.g., in the memory 1406 and executed by the one or more processors 1404.

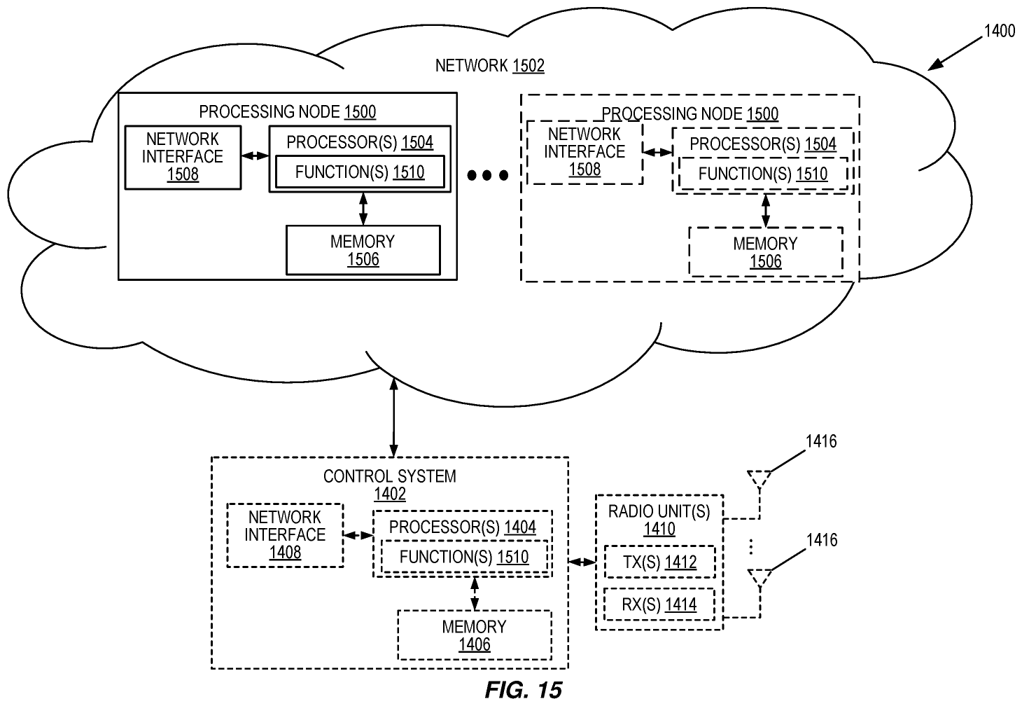

FIG. 15 is a schematic block diagram that illustrates a virtualized embodiment of the radio access node 1400 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1400 in which at least a portion of the functionality of the radio access node 1400 is implemented as a virtual component(s) (e.g., via a virtual machine(s) executing on a physical processing node(s) in a network(s)). As illustrated, in this example, the radio access node 1400 may include the control system 1402 and/or the one or more radio units 1410, as described above. The control system 1402 may be connected to the radio unit(s) 1410 via, for example, an optical cable or the like. The radio access node 1400 includes one or more processing nodes 1500 coupled to or included as part of a network(s) 1502. If present, the control system 1402 or the radio unit(s) are connected to the processing node(s) 1500 via the network 1502. Each processing node 1500 includes one or more processors 1504 (e.g., CPUs, ASICs, FPGAs, and/or the like), memory 1506, and a network interface 1508.

In this example, functions 1510 of the radio access node 1400 described herein (e.g., one or more functions of the network node 702, base station 602, gNB, gNB-CU, or gNB-DU, as described herein) are implemented at the one or more processing nodes 1500 or distributed across the one or more processing nodes 1500 and the control system 1402 and/or the radio unit(s) 1410 in any desired manner. In some particular embodiments, some or all of the functions 1510 of the radio access node 1400 described herein are implemented as virtual components executed by one or more virtual machines implemented in a virtual environment(s) hosted by the processing node(s) 1500. As will be appreciated by one of ordinary skill in the art, additional signaling or communication between the processing node(s) 1500 and the control system 1402 is used in order to carry out at least some of the desired functions 1510. Notably, in some embodiments, the control system 1402 may not be included, in which case the radio unit(s) 1410 communicate directly with the processing node(s) 1500 via an appropriate network interface(s).

In some embodiments, a computer program including instructions which, when executed by at least one processor, causes the at least one processor to carry out the functionality of radio access node 1400 or a node (e.g., a processing node 1500) implementing one or more of the functions 1510 of the radio access node 1400 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 16 is a schematic block diagram of the radio access node 1400 according to some other embodiments of the present disclosure. The radio access node 1400 includes one or more modules 1600, each of which is implemented in software. The module(s) 1600 provide the functionality of the radio access node 1400 described herein (e.g., one or more functions of the network node 702, base station 602, gNB, gNB-CU, or gNB-DU, as described herein). This discussion is equally applicable to the processing node 1500 of FIG. 15 where the modules 1600 may be implemented at one of the processing nodes 1500 or distributed across multiple processing nodes 1500 and/or distributed across the processing node(s) 1500 and the control system 1402.

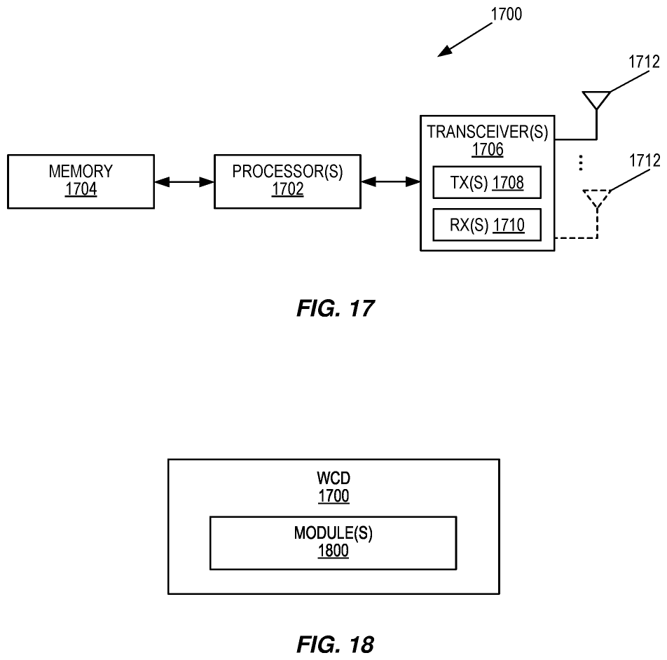

FIG. 17 is a schematic block diagram of a WCD 1700 according to some embodiments of the present disclosure. The WCD 1700 may be the WCD 612 or the WCD 704 as described herein. As illustrated, the WCD 1700 includes one or more processors 1702 (e.g., CPUs, ASICs, FPGAs, and/or the like), memory 1704, and one or more transceivers 1706 each including one or more transmitters 1708 and one or more receivers 1710 coupled to one or more antennas 1712. The transceiver(s) 1706 includes radio-front end circuitry connected to the antenna(s) 1712 that is configured to condition signals communicated between the antenna(s) 1712 and the processor(s) 1702, as will be appreciated by on of ordinary skill in the art. The processors 1702 are also referred to herein as processing circuitry. The transceivers 1706 are also referred to herein as radio circuitry. In some embodiments, the functionality of the WCD 1700 described herein (e.g., one or more functions of the WCD 612, WCD 704, or UE, as described herein) may be fully or partially implemented in software that is, e.g., stored in the memory 1704 and executed by the processor(s) 1702. Note that the WCD 1700 may include additional components not illustrated in FIG. 17 such as, e.g., one or more user interface components (e.g., an input/output interface including a display, buttons, a touch screen, a microphone, a speaker(s), and/or the like and/or any other components for allowing input of information into the WCD 1700 and/or allowing output of information from the WCD 1700), a power supply (e.g., a battery and associated power circuitry), etc.

In some embodiments, a computer program including instructions which, when executed by at least one processor, causes the at least one processor to carry out the functionality of the WCD 1700 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 18 is a schematic block diagram of the WCD 1700 according to some other embodiments of the present disclosure. The WCD 1700 includes one or more modules 1800, each of which is implemented in software. The module(s) 1800 provide the functionality of the WCD 1700 described herein (e.g., one or more functions of the WCD 612, WCD 704, or UE, as described herein).

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

### EMBODIMENTS

Embodiment 1: A computer implemented method performed by a wireless communication device, WCD, (704), the method comprising receiving (904) information from a network node (704), the information comprising an AI/ML model (710) that outputs a set of output parameters that represent whether a random access, RA, procedure to be performed by the WCD (704) will be successful based on a set of input parameters, or information about or that characterizes the AI/ML model (710) that enables the WCD (704) to build the AI/ML model (710). The method comprising adapting (906) one or more RA parameters for the RA procedure based on the AI/ML model (710).

Embodiment 2: The method of embodiment 1 further comprising performing (908) the RA procedure based on the one or more adapted RA parameters.

Embodiment 3: The method of embodiment 2 further comprising providing (910) feedback about the AI/ML model (710) to the network node (704).

Embodiment 4: The method of embodiment 3 wherein the feedback comprises an output of the AI/ML model (710) and/or information that indicates an accuracy of the AI/ML model (710).

Embodiment 5: The method of any of embodiments 1 to 4 wherein the set of input parameters of the AI/ML model (710) comprise:
a) a frequency of a cell on which the RA procedure is to be performed;
b) a cell ID of the cell on which the RA procedure is to be performed;
c) a TAC of the cell on which the RA procedure is to be performed;
d) a PLMN ID of a PLMN of the cell on which the RA procedure is to be perform;
e) set of the beams to be used to perform the RA procedure;
f) cell and/or beam level measurements of a serving cell of the WCD (704);
g) cell and/or beam level measurements of the cell in which the RA procedure is to be performed;
h) a RACH transmission power level to be used for the RA procedure (e.g., for an initial preamble transmission);
i) cell and/or beam level measurements of one or more inter-frequency neighboring cells and/or one or more intra-frequency neighboring cells of the WCD (704);
j) measurement of uplink resources used by the WCD (704);
k) interference measurement(s) performed by a radio unit of a serving cell of the WCD (704) and/or by a radio unit of one or more neighboring cells of the WCD (704);
l) a timing advance of the WCD (704);
m) location information for the WCD (704);
n) time (either absolute or relative time) information for the WCD (704);
o) Minimization of Derive Test (MDT) measurements;
p) a power ramping value associated with the WCD (704);
q) any or all possible RACH configuration parameters in different RATs that are available;
r) a RACH report from the WCD (704); or
s) a combination of any two or more of (a)-(r).

Embodiment 6: The method of any of embodiments 1 to 5 wherein the one or more output parameters of the AI/ML model (710) comprise:
i. an estimated success or failure of the RA procedure given values for the set of input parameters;
ii. a success probability of the RA procedure given the values of the set of input parameters;
iii. a failure probability of the RA procedure given the values of the set of input parameters;
iv. a probability of having a successful random access on a first random access attempt of the RA procedure;
v. a probability of having a successful random access in multiple attempts of the RA procedure;
vi. a probability of successful random access after a defined number of random access attempts of the RA procedure;
vii. a prediction of an actual number of random access attempts for successful random access;
viii. a prediction of a number of random access attempts for a given success probability;
ix. an actual RACH transmission power to be used for the RA procedure; or
x. a combination of any two or more of (i)-(ix).

Embodiment 7: The method of any of embodiments 1 to 6 wherein the one or more output parameters are either per beam or per cell.

Embodiment 8: The method of any of embodiments 1 to 7 wherein the one or more RA parameters comprise:
A. an initial power level to be used by the WCD (704) to transmit an uplink signal including an initial preamble transmission for the RA procedure (e.g., per beam or per cell);
B. a modulation and coding scheme, MCS, used for transmission of message 3 or message 5 in a 4-step RACH procedure;
C. a MCS used for PUSCH resources in a 2-step RACH procedure;
D. power ramping step per beam,
E. maximum number of random access attempts (i.e., maximum number of preamble transmissions);
F. a set of beams to be used by the WCD (704) for the RA procedure;
G. a decision on whether to perform a 2-step RACH procedure or a 4-step RACH procedure; or
H. a combination of any two or more of A-G.

Embodiment 9: The method of any of embodiments 1 to 8 wherein adapting (906) the one or more RA parameters for the RA procedure based on the AI/ML model (710) comprises:

obtaining (1000) a first set of values for the set of input parameters based on a first set of values for the one or more RA parameters;
feeding (1000) the first set of values for the set of input parameters into the AI/ML model (710);
obtaining (1002) a set of values for the set of output parameters output by the AI/ML model (710) responsive to the first set of values for the set of input parameters;
determining (1004) whether adaptation of at least one of the one or more RA parameters is needed based on the set of values for the set of output parameters output by the AI/ML model (710);
upon determining (1004, YES) that adaptation is needed, changing at least one of the first set of values for the one or more RA parameters to provide a second set of values for the one or more RA parameters.

Embodiment 10: The method of embodiment 9 adapting (906) the one or more RA parameters for the RA procedure based on the AI/ML model (710) further comprises:
obtaining (1000) a second set of values for the set of input parameters based on the second set of values for the one or more RA parameters;
feeding (1000) the second set of values for the set of input parameters into the AI/ML model (710);
obtaining (1002) a second set of values for the set of output parameters output by the AI/ML model (710) responsive to the second set of values for the set of input parameters;
determining (1004) whether adaptation of at least one of the one or more RA parameters is needed based on the second set of values for the set of output parameters output by the AI/ML model (710); and
upon determining (1004, YES) that adaptation is needed, changing at least one of the second set of values for the one or more RA parameters to provide a third set of values for the one or more RA parameters.

Embodiment 11: The method of any of embodiments 1 to 10 further comprising receiving (FIG. 12, step 2), from the network node, information that defines a validity area for the AI/ML model (710), wherein adapting (906) the one or more RA parameters for the RA procedure based on the AI/ML model (710) comprises adapting (906) the one or more RA parameters for the RA procedure based on the AI/ML model (710) while the WCD (704) is within the validity area defined for the AI/ML model (710).

Embodiment 12: The method of any of embodiments 1 to 11 further comprising sending (900), to the network node (702), information that indicates a capability of the WCD (704) to execute the AI/ML model (710).

Embodiment 13: A wireless communication device, WCD, (704) adapted to perform the method of any of embodiments 1 to 12.

Embodiment 14: A wireless communication device, WCD, (704) comprising:
one or more transmitters (1708);
one or more receivers (1710); and
processing circuitry (1702) associated with the one or more transmitters (1708) and the one or more receivers (1710), the processing circuitry (1702) configured to cause the WCD (704) to perform the method of any of embodiments 1 to 12.

Embodiment 15: A non-transitory computer readable medium comprising instructions executable by processing circuitry of a wireless communication device (WCD) whereby the WCD is caused to perform the method of any of embodiments 1 to 12.

Embodiment 16: A computer program comprising instructions which, when executed on at least one processor, cause the at least one processor to carry out the method according to any of embodiments 1 to 12.

Embodiment 17: A carrier containing the computer program of embodiment 16, wherein the carrier is one of an electronic signal, an optical signal, a radio signal, or a computer readable storage medium.

Embodiment 18: A computer implemented method performed by a network node (702), the method comprising:
obtaining (800; 902) an AI/ML model (710) that outputs a set of output parameters that represent whether a RA procedure to be performed by a WCD (704) will be successful based on a set of input parameters; and
sending (802) information to another node, the information comprising:
the AI/ML model (710); or
information about or that characterizes the AI/ML model (710).

Embodiment 19: The method of embodiment 18 wherein the another node is another network node or a WCD (704).

Embodiment 20: The method of any of embodiments 18 or 19 wherein the set of input parameters of the AI/ML model (710) comprise:
a) a frequency of a cell on which the RA procedure is to be performed;
b) a cell ID of the cell on which the RA procedure is to be performed;
c) a TAC of the cell on which the RA procedure is to be performed;
d) a PLMN ID of a PLMN of the cell on which the RA procedure is to be perform;
e) set of the beams to be used to perform the RA procedure;
f) cell and/or beam level measurements of a serving cell of the WCD (704);
g) cell and/or beam level measurements of the cell in which the RA procedure is to be performed;
h) a RACH transmission power level to be used for the RA procedure (e.g., for an initial preamble transmission);
i) cell and/or beam level measurements of one or more inter-frequency neighboring cells and/or one or more intra-frequency neighboring cells of the WCD (704);
j) measurement of uplink resources used by the WCD (704);
k) interference measurement(s) performed by a radio unit of a serving cell of the WCD (704) and/or by a radio unit of one or more neighboring cells of the WCD (704);
l) a timing advance of the WCD (704);
m) location information for the WCD (704);
n) time (either absolute or relative time) information for the WCD (704);
o) Minimization of Derive Test (MDT) measurements;
p) a power ramping value associated with the WCD (704);
q) any or all possible RACH configuration parameters in different RATs that are available;
r) a RACH report from the WCD (704); or
s) a combination of any two or more of (a)-(r).

Embodiment 21: The method of any of embodiments 18 to 20 wherein the one or more output parameters of the AI/ML model (710) comprise:
i. an estimated success or failure of the RA procedure given values for the set of input parameters;
ii. a success probability of the RA procedure given the values of the set of input parameters;
iii. a failure probability of the RA procedure given the values of the set of input parameters;
iv. a probability of having a successful random access on a first random access attempt of the RA procedure;
v. a probability of having a successful random access in multiple attempts of the RA procedure;
vi. a probability of successful random access after a defined number of random access attempts of the RA procedure;
vii. a prediction of an actual number of random access attempts for successful random access;
viii. a prediction of a number of random access attempts for a given success probability;
ix. an actual RACH transmission power to be used for the RA procedure; or
x. a combination of any two or more of (i)-(ix).

Embodiment 22: The method of any of embodiments 18 to 21 wherein the one or more output parameters are either per beam or per cell.

Embodiment 23: The method of any of embodiments 18 to 22 wherein the one or more RA parameters comprise:
A. an initial power level to be used by the WCD (704) to transmit an uplink signal including an initial preamble transmission for the RA procedure (e.g., per beam or per cell);
B. a modulation and coding scheme, MCS, used for transmission of message 3 or message 5 in a 4-step RACH procedure;
C. a MCS used for PUSCH resources in a 2-step RACH procedure;
D. power ramping step per beam,
E. maximum number of random access attempts (i.e., maximum number of preamble transmissions);
F. a set of beams to be used by the WCD (704) for the RA procedure;
G. a decision on whether to perform a 2-step RACH procedure or a 4-step RACH procedure; or
H. a combination of any two or more of A-G.

Embodiment 24: The method of any of embodiments 18 to 23 further comprising sending (FIG. 12, step 2), to the another node, information that defines a validity area for the AI/ML model (710).

Embodiment 25: A computer implemented method performed by a network node (702), the method comprising:
obtaining (800) an AI/ML model (710) that outputs a set of output parameters that represent whether a RA procedure will be successful based on a set of input parameters;
adapting (802) one or more RA parameters for a RA procedure to be performed by a WCD (704) based on the AI/ML model (710); and
sending (804) the one or more adapted RA parameters to the WCD (704).

Embodiment 26: The method of embodiment 25 wherein the set of input parameters of the AI/ML model (710) comprise:
a) a frequency of a cell on which the RA procedure is to be performed;
b) a cell ID of the cell on which the RA procedure is to be performed;
c) a TAC of the cell on which the RA procedure is to be performed;
d) a PLMN ID of a PLMN of the cell on which the RA procedure is to be perform;
e) set of the beams to be used to perform the RA procedure;
f) cell and/or beam level measurements of a serving cell of the WCD (704);
g) cell and/or beam level measurements of the cell in which the RA procedure is to be performed;
h) a RACH transmission power level to be used for the RA procedure (e.g., for an initial preamble transmission);
i) cell and/or beam level measurements of one or more inter-frequency neighboring cells and/or one or more intra-frequency neighboring cells of the WCD (704);
j) measurement of uplink resources used by the WCD (704);
k) interference measurement(s) performed by a radio unit of a serving cell of the WCD (704) and/or by a radio unit of one or more neighboring cells of the WCD (704);
l) a timing advance of the WCD (704);
m) location information for the WCD (704);
n) time (either absolute or relative time) information for the WCD (704);
o) Minimization of Derive Test (MDT) measurements;
p) a power ramping value associated with the WCD (704);
q) any or all possible RACH configuration parameters in different RATs that are available;
r) a RACH report from the WCD (704); or
s) a combination of any two or more of (a)-(r).

Embodiment 27: The method of any of embodiments 25 to 26 wherein the one or more output parameters of the AI/ML model (710) comprise:
i. an estimated success or failure of the RA procedure given values for the set of input parameters;
ii. a success probability of the RA procedure given the values of the set of input parameters;
iii. a failure probability of the RA procedure given the values of the set of input parameters;
iv. a probability of having a successful random access on a first random access attempt of the RA procedure;
v. a probability of having a successful random access in multiple attempts of the RA procedure;
vi. a probability of successful random access after a defined number of random access attempts of the RA procedure;
vii. a prediction of an actual number of random access attempts for successful random access;
viii. a prediction of a number of random access attempts for a given success probability;
ix. an actual RACH transmission power to be used for the RA procedure; or
x. a combination of any two or more of (i)-(ix).

Embodiment 28: The method of any of embodiments 25 to 27 wherein the one or more output parameters are either per beam or per cell.

Embodiment 29: The method of any of embodiments 25 to 28 wherein the one or more RA parameters comprise:
A. an initial power level to be used by the WCD (704) to transmit an uplink signal including an initial preamble transmission for the RA procedure (e.g., per beam or per cell);
B. a modulation and coding scheme, MCS, used for transmission of message 3 or message 5 in a 4-step RACH procedure;
C. a MCS used for PUSCH resources in a 2-step RACH procedure;
D. power ramping step per beam,
E. maximum number of random access attempts (i.e., maximum number of preamble transmissions);
F. a set of beams to be used by the WCD (704) for the RA procedure;
G. a decision on whether to perform a 2-step RACH procedure or a 4-step RACH procedure; or
H. a combination of any two or more of A-G.

Embodiment 30: The method of any of embodiments 25 to 29 wherein adapting (802) the one or more RA parameters for the RA procedure based on the AI/ML model (710) comprises:
obtaining (1000) a first set of values for the set of input parameters based on a first set of values for the one or more RA parameters;
feeding (1000) the first set of values for the set of input parameters into the AI/ML model (710);
obtaining (1002) a set of values for the set of output parameters output by the AI/ML model (710) responsive to the first set of values for the set of input parameters;
determining (1004) whether adaptation of at least one of the one or more RA parameters is needed based on the set of values for the set of output parameters output by the AI/ML model (710);
upon determining (1004, YES) that adaptation is needed, changing at least one of the first set of values for the one or more RA parameters to provide a second set of values for the one or more RA parameters.

Embodiment 31: The method of embodiment 30 adapting (802) the one or more RA parameters for the RA procedure based on the AI/ML model (710) further comprises:
obtaining (1000) a second set of values for the set of input parameters based on the second set of values for the one or more RA parameters;
feeding (1000) the second set of values for the set of input parameters into the AI/ML model (710);
obtaining (1002) a second set of values for the set of output parameters output by the AI/ML model (710) responsive to the second set of values for the set of input parameters;
determining (1004) whether adaptation of at least one of the one or more RA parameters is needed based on the second set of values for the set of output parameters output by the AI/ML model (710); and
upon determining (1004, YES) that adaptation is needed, changing at least one of the second set of values for the one or more RA parameters to provide a third set of values for the one or more RA parameters.

Embodiment 32: A network node (804) adapted to perform the method of any of embodiments 13 to 31.

Embodiment 33: A network node (804) comprising processing circuitry (1404; 1504) configured to cause the network node to perform the method of any of embodiments 13 to 31.

Embodiment 34: A non-transitory computer readable medium comprising instructions executable by processing circuitry of a network node whereby the network node is caused to perform the method of any of embodiments 18 to 31.

Embodiment 35: A computer program comprising instructions which, when executed on at least one processor, cause the at least one processor to carry out the method according to any of embodiments 18 to 31.

Embodiment 36: A carrier containing the computer program of embodiment 35, wherein the carrier is one of an electronic signal, an optical signal, a radio signal, or a computer readable storage medium.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AI Artificial Intelligence
AMF Access and Mobility Function
AN Access Network
AP Access Point
ASIC Application Specific Integrated Circuit
AUSF Authentication Server Function
CPU Central Processing Unit
DN Data Network
DSP Digital Signal Processor
eNB Enhanced or Evolved Node B
EPC Evolved Packet Core
EPS Evolved Packet System
E-UTRA Evolved Universal Terrestrial Radio Access
FPGA Field Programmable Gate Array
gNB New Radio Base Station
gNB-CU New Radio Base Station Central Unit
gNB-DU New Radio Base Station Distributed Unit
HSS Home Subscriber Server
ID Identifier
IMSI International Mobile Subscriber Identity
IoT Internet of Things
IP Internet Protocol
LTE Long Term Evolution
MAC Medium Access Control
MCS Modulation and Coding Scheme
MDT Minimization of Derive Test
ML Machine Learning
MME Mobility Management Entity
MTC Machine Type Communication
NEF Network Exposure Function
NF Network Function
NR New Radio
NRF Network Function Repository Function
NSSF Network Slice Selection Function
OAM Operation and Maintenance Unit
OTT Over-the-Top
PC Personal Computer
PCF Policy Control Function
P-GW Packet Data Network Gateway
PLMN Public Land Mobile Network
PUSCH Physical Uplink Shared Channel
QoS Quality of Service
RA Random Access
RACH Random Access Channel
RAM Random Access Memory
RAN Radio Access Network
RAR Random Access Response
RAT Radio Access Technology
ROM Read Only Memory
RRC Radio Resource Control
RRH Remote Radio Head
RTT Round Trip Time
SCEF Service Capability Exposure Function
SMF Session Management Function
SRS Sounding Reference Signal
SSB Synchronization Signal Block
TAC Tracking Area Code
UDM Unified Data Management
UE User Equipment
UPF User Plane Function
URLLC Ultra-Reliable Low-Latency Communication
WCD Wireless Communication Device

Those skilled in the art will recognize improvements and modifications to the embodiments of the present disclosure. All such improvements and modifications are considered within the scope of the concepts disclosed herein.

1. A computer implemented method performed by a Wireless Communication Device, WCD, the method comprising:
receiving information from a network node, the information comprising:
an Artificial Intelligence, AI/Machine Learning, ML, model that outputs a set of output parameters that represent whether a Random Access, RA, procedure to be performed by the WCD will be successful based on a set of input parameters; or
information about or that characterizes the AI/ML model that enables the WCD to build the AI/ML model that outputs the set of output parameters that represent whether the RA procedure to be performed by the WCD will be successful based on the set of input parameters; and
adapting one or more RA parameters for the RA procedure based on the AI/ML model.

2. The method of claim 1, further comprising performing the RA procedure based on the one or more adapted RA parameters.

3. The method of claim 2, further comprising providing feedback about the AI/ML model to the network node.

4. The method of claim 3, wherein the feedback comprises an output of the AI/ML model and/or information that indicates an accuracy of the AI/ML model.

5. The method of claim 3, wherein providing the feedback about the AI/ML model to the network node comprises:
training the AI/ML model based at least in part on the RA procedure and the one or more adapted parameters to obtain an updated version of the AI/ML model.

6. The method of claim 5, wherein providing the feedback about the AI/ML model to the network node further comprises:
providing, to the network node:
(a) the updated version of the AI/ML model;
(b) data descriptive of updates to the AI/ML model included in the updated version of the AI/ML model;
(c) the set of input parameters; or
(d) instructions to perform the updates to the AI/ML model included in the updated version of the AI/ML model.

7. The method of claim 1, wherein the set of input parameters of the AI/ML model comprise:
a) a frequency of a cell on which the RA procedure is to be performed;
b) a cell Identifier, ID, of the cell on which the RA procedure is to be performed;
c) a Tracking Area Code, TAC, of the cell on which the RA procedure is to be performed;
d) a Public Land Mobile Network, PLMN, ID of a PLMN of the cell on which the RA procedure is to be perform;
e) set of the beams to be used to perform the RA procedure;
f) cell and/or beam level measurements of a serving cell of the WCD;
g) cell and/or beam level measurements of the cell in which the RA procedure is to be performed;
h) a Random Access Channel, RACH, transmission power level to be used for the RA procedure;
i) cell and/or beam level measurements of one or more inter-frequency neighboring cells and/or one or more intra-frequency neighboring cells of the WCD;
j) measurement of uplink resources used by the WCD;
k) interference measurement(s) performed by a radio unit of a serving cell of the WCD and/or by a radio unit of one or more neighboring cells of the WCD;
l) a timing advance of the WCD;
m) location information for the WCD;
n) absolute time information or relative time information for the WCD;
o) Minimization of Derive Test, MDT, measurements;
p) a power ramping value associated with the WCD;
q) any or all possible RACH configuration parameters in different Radio Access Technologies, RATs, that are available;
r) a RACH report from the WCD; or
s) a combination of any two or more of (a)-(r).

8. The method of claim 1, wherein the one or more output parameters of the AI/ML model comprise:
i) an estimated success or failure of the RA procedure given values for the set of input parameters;
ii) a success probability of the RA procedure given the values of the set of input parameters;
iii) a failure probability of the RA procedure given the values of the set of input parameters;
iv) a probability of having a successful random access on a first random access attempt of the RA procedure;
v) a probability of having a successful random access in multiple attempts of the RA procedure;
vi) a probability of successful random access after a defined number of random access attempts of the RA procedure;
vii) a prediction of an actual number of random access attempts for successful random access;
viii) a prediction of a number of random access attempts for a given success probability;
ix) an actual RACH transmission power to be used for the RA procedure; or
x) a combination of any two or more of (i)-(ix).

9. The method of claim 1, wherein the one or more output parameters are either per beam or per cell.

10. The method of claim 1, wherein the one or more RA parameters comprise:
A. an initial power level to be used by the WCD to transmit an uplink signal including an initial preamble transmission for the RA procedure, wherein the initial power level comprises a per beam initial power level and/or a per cell initial power level);
B. a Modulation and Coding Scheme, MCS, used for transmission of message 3 or message 5 in a 4-step RACH procedure;
C. a MCS used for Physical Uplink Shared Channel, PUSCH, resources in a 2-step RACH procedure;
D. power ramping step per beam;
E. maximum number of random access attempts (i.e., maximum number of preamble transmissions);
F. a set of beams to be used by the WCD for the RA procedure;
G. a decision on whether to perform a 2-step RACH procedure or a 4-step RACH procedure; or
H. a combination of any two or more of A-G.

11. The method of claim 1, wherein adapting the one or more RA parameters for the RA procedure based on the AI/ML model comprises:
obtaining a first set of values for the set of input parameters based on a first set of values for the one or more RA parameters;
feeding the first set of values for the set of input parameters into the AI/ML model;
obtaining a set of values for the set of output parameters output by the AI/ML model responsive to the first set of values for the set of input parameters;
determining whether adaptation of at least one of the one or more RA parameters is needed based on the set of values for the set of output parameters output by the AI/ML model; and
upon determining that adaptation is needed, changing at least one of the first set of values for the one or more RA parameters to provide a second set of values for the one or more RA parameters.

12. The method of claim 11, wherein adapting the one or more RA parameters for the RA procedure based on the AI/ML model further comprises:
obtaining a second set of values for the set of input parameters based on the second set of values for the one or more RA parameters;
feeding the second set of values for the set of input parameters into the AI/ML model;
obtaining a second set of values for the set of output parameters output by the AI/ML model responsive to the second set of values for the set of input parameters;
determining whether adaptation of at least one of the one or more RA parameters is needed based on the second set of values for the set of output parameters output by the AI/ML model; and
upon determining that adaptation is needed, changing at least one of the second set of values for the one or more RA parameters to provide a third set of values for the one or more RA parameters.

13. The method of claim 1, further comprising receiving, from the network node, information that defines a validity area for the AI/ML model, wherein adapting the one or more RA parameters for the RA procedure based on the AI/ML model comprises adapting the one or more RA parameters for the RA procedure based on the AI/ML model while the WCD is within the validity area defined for the AI/ML model.

14. The method of claim 1, further comprising sending, to the network node, information that indicates a capability of the WCD to execute the AI/ML model.

15. The method of claim 1, wherein the AI/ML model is previously trained based at least in part on previously obtained WCD capability information.

16. The method of claim 1, further comprising:
receiving, from the network node, instructions to execute the AI/ML model using a certain configuration to obtain an additional set of output parameters;
executing the AI/ML model using the certain configuration to obtain the additional set of output parameters; and
providing, to the network node, the additional set of output parameters.

17. The method of claim 1, wherein receiving the information from the network node comprises:
receiving the information about or that characterizes the AI/ML model that enables the WCD to build the AI/ML model that outputs the set of output parameters that represent whether the RA procedure to be performed by the WCD will be successful based on the set of input parameters; and
building the AI/ML model based at least in part on the information.

18-19. (canceled)

20. A Wireless Communication Device, WCD, comprising:
one or more transmitters;
one or more receivers; and
processing circuitry associated with the one or more transmitters and the one or more receivers, the processing circuitry configured to cause the WCD to:
receive information from a network node, the information comprising:
an Artificial Intelligence, AI/Machine Learning, ML, model that outputs a set of output parameters that represent whether a Random Access, RA, procedure to be performed by the WCD will be successful based on a set of input parameters; or
information about or that characterizes the AI/ML model that enables the WCD to build the AI/ML model that outputs the set of output parameters that represent whether the RA procedure to be performed by the WCD will be successful based on the set of input parameters; and
adapt one or more RA parameters for the RA procedure based on the AI/ML model.

21-25. (canceled)

26. A computer implemented method performed by a network node, the method comprising:
obtaining an Artificial Intelligence, AI/Machine Learning, ML, model that outputs a set of output parameters that represent whether a Random Access, RA, procedure to be performed by a Wireless Communication Device, WCD, will be successful based on a set of input parameters; and
sending information to another node, the information comprising:
the AI/ML model; or
information about or that characterizes the AI/ML model.

27-36. (canceled)

37. A network node, comprising:
one or more transmitters;
one or more receivers; and
processing circuitry, associated with the one or more transmitters and the one or more receivers, the processing circuitry configured to cause the network node to:
obtain an Artificial Intelligence, AI/Machine Learning, ML, model that outputs a set of output parameters that represent whether a Random Access, RA, procedure to be performed by a Wireless Communication Device, WCD, will be successful based on a set of input parameters; and
send information to another node, the information comprising:
the AI/ML model; or
information about or that characterizes the AI/ML model.

38-53. (canceled)
